(19) United States
(12) Patent Application Publication
(10) Pub. No.: US 2019/0359472 A1
(43) Pub. Date: Nov. 28, 2019

(54) FOOD GRADE DISPOSABLE CONTAINER WITH A ONE OUNCE (1 OZ.) OR ONE-AND-A-HALF OUNCE (1.5 OZ.) TAP FOR POURING ALCOHOL WITH A COUNTERTOP DISPENSING STAND DEVICE, SYSTEM, AND METHOD

(71) Applicant: BIAB HOLDINGS INC., Stoney Creek (CA)

(72) Inventors: Paul Neelin, Stoney Creek (CA); Diane Hope, Stoney Creek (CA)

(21) Appl. No.: 16/424,370

(22) Filed: May 28, 2019

Related U.S. Application Data
(60) Provisional application No. 62/677,104, filed on May 28, 2018.

(51) Int. Cl. B67D 3/00; B65D 77/06; B65D 75/58

(52) U.S. Cl. CPC B67D 3/0045; B65D 75/008; B65D 75/5855; B65D 77/065

(57) ABSTRACT

A metered tap includes a pouring spout and a sliding section. The spout accurately dispenses, from an internal reservoir of a container, a predetermined one or one-and-a-half ounce volume of alcohol in a controlled single pour with precision. The metered tap is movable between retracted and extended configurations. The sliding section has an internal chamber to contain the volume, and a top portion with fill openings into the internal chamber. In the retracted configuration, the sliding section is within the container, and the alcohol flows from the internal reservoir into the internal chamber through the fill openings. In the extended configuration, the sliding section is extended relative to the retracted configuration, and blocks flow of alcohol from the internal reservoir. When the pouring spout is selectively actuated, the alcohol is dispensed and empties from the internal chamber by gravity flow. Also disclosed are a dispensing stand and method of use.

### FIELD OF THE INVENTION

The present invention relates generally to alcohol dispensing containers and, more particularly, to a food grade disposable bag and/or a box with a one ounce (1 oz.) and/or one-and-a-half ounce (1.5 oz.) tap for pouring alcohol and/or with a countertop dispensing stand device, system, and/or method.

### BACKGROUND OF THE INVENTION

Art in analogous or non-analogous fields may have included food grade disposable bags and boxes for dispensing beverages, including, for example, wine and mixed alcoholic drinks. Such bags and boxes, however, may have themselves failed to provide for a controlled a one ounce (1 oz.) or one-and-a-half ounce (1.5 oz.) pour of fluid. Instead, any such prior art bags and boxes may have been provided with a generic constant flow tap.

The prior art may have persisting problems and/or shortcomings including, among others, a failure to provide an alcohol bag having a tap device specifically designed for simple and easy use. Additionally, the prior art may have failed to disclose a food grade disposable bag and/or a box with a one ounce (1 oz.) and/or one-and-a-half ounce (1.5 oz.) tap for pouring alcohol and/or with a counter-top dispensing stand device, system, and/or method.

It may be an object according to one aspect of the invention to provide a food grade disposable bag and/or a box with a one ounce (1 oz.) and/or one-and-a-half ounce (1.5 oz.) tap for pouring alcohol and/or with a counter-top dispensing stand device, system, and/or method.

It may be an object according to one aspect of the invention to provide a device, system, and/or method which enables a pour of exactly 1 oz. (or 1.5 oz.) pour from a disposable bag.

It may be an object according to one aspect of the invention to provide a food grade disposable bag or a box, having a 1 oz. (or 1.5 oz.) tap for pouring alcohol, with a counter-top dispensing stand, which in whole or in part provides, includes, and/or affords one or more of the following features, steps, and/or utilities:
Uses green and/or disposable materials;
Has a bag with an integral; single-piece, and/or pull-out tap;
For home use and/or for the restaurant or hospitality industry;
Help with accurate inventory controls;
Made from substantially durable or semi-permanent materials;
Has a stand that securely holds the bags, is suited for different decors, accommodates ready pour into glasses, and/or displays one or more brand to consumers;
Has a tap adapted for shipping, storage, and/or to prevent unauthorized access;
Has a tap with a tamper-proof seal;
Has a gravity-fed tap which slides between a retracted filling position and an extended pouring position; and/or
Allow a single 1 oz. (or 1.5 oz.) to pour at a time or with a single push, before automatically stopping, unless or until the next pour.

It is an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a food grade disposable bag and/or a box with a one ounce (1 oz.) and/or one-and-a-half ounce (1.5 oz.) tap for pouring alcohol and/or with a countertop dispensing stand device, system, and/or method.

According to an aspect of one preferred embodiment, the device, system, and/or method according to the invention may provide for an exact 1 oz. (or 1.5 oz.) pour of alcohol from a food grade disposable bag.

According to an aspect of one preferred embodiment, the device, system, and/or method according to the invention may incorporate green and/or disposable materials, e.g., a food grade disposable bag.

According to an aspect of one preferred embodiment, the bag and tap may be attached as one. The tap may preferably, but need not necessarily, be a single-piece pull out (1 oz. and/or 1.5 oz.) tap.

According to an aspect of one preferred embodiment, the device, system, and/or method according to the invention may have been developed, designed, and/or created at least in part for the hospitality industry, and/or preferably to meet, accommodate, and/or facilitate management of internal inventory control, associated metrics, and/or other demands of the hospitality industry. The invention may be particularly well-adapted for home use and/or for the restaurant or hospitality industry, where accurate inventory controls may be in place, especially with respect to the alcohol and/or beverage portion of the business.

According to an aspect of one preferred embodiment, a disposable (green inspired) food grade bag may be filled with alcoholic spirits (e.g., vodka, rum, rye whiskey, gin, tequila, bourbon) and enable a controlled 1 oz. (or 1.5 oz.) single pour to facilitate management and/or direct control of inventory.

According to an aspect of one preferred embodiment, the food grade disposable bag may be returned (e.g., for a deposit) or recycled.

According to an aspect of one preferred embodiment, the device, system, and/or method according to the invention may provide for a controlled 1 oz. single pour. According to an aspect of another preferred embodiment, the device, system, and/or method according to the invention may enable a controlled 1.5 oz. single pour for restaurants, bars, and/or other establishments that offer a 1.5 oz. pour.

According to an aspect of one preferred embodiment, a countertop dispensing stand may be provided, to hold the bags, which may be (A) substantially permanent and made from substantially durable materials, or (B) only semi-permanent, made from less durable materials, and/or intended for disposal or recycling after use over a season or at one or more events. The stand may preferably, but need not necessarily, be adapted to hold substantially about 8.0 pounds (or substantially about 3.7 kilograms) of weight in held bags.

According to an aspect of one preferred embodiment, the stand may be made from commercial grade corrugated plastic. The stand may preferably, but need not necessarily, be printed, have a veneer, or otherwise appear to made from and/or to resemble corrugated metal and/or wood. Restaurants may preferably have their choice from two or more countertop stand models, which may be designed, coloured, patterned, and/or ornamented for different decors.

According to an aspect of one preferred embodiment, three (3) divider inserts may be provided for the stand to create four sections. Each section may preferably hold a single bag, as supported by the stand and one or more of the divider inserts. A front face of the stand may preferably be pre-punched and/or shaped to define four (4) open holes. Each hole may preferably be sized and shaped to receive and accommodate a respective one bag's pouring tap, which extends therethrough. The stand may preferably be provided with a separate drip tray. Preferably, the stand may be provided with legs to keep the stand substantially about two (2) inches above the countertop. The holes and leg heights, and/or other aspects of the stand, may preferably be sized and positioned to accommodate rock glasses and/or pint glasses beneath the tap and above the drip tray.

According to an aspect of one preferred embodiment, the countertop dispensing stand may have a distinctive stand display surface. A distinctive stand brand, trademark, and/or other indicia for the bags, stand, and/or alcohol may preferably be applied to and presented from the stand display surface. The stand with its display surface may preferably be adapted to readily present, therefrom, the stand brand to users, consumers, and/or patrons.

According to an aspect of one preferred embodiment, the bags may have a distinctive bag display surface. A distinctive bag brand, trademark, and/or other indicia for the bags and/or alcohol may preferably be applied to and presented from the bag display surface. The bag with its display surface and the countertop dispensing stand may preferably be together adapted to readily present, therefrom, the bag brand to users, consumers, and/or patrons when the bag is held on and/or by the stand. That is, the brand on the bag may preferably be readily visible when the bag is on the stand.

According to an aspect of one preferred embodiment, the tap may be (A) preferably on a front face of the spirits bag, and/or (B) alternately on a side end of the bag.

According to an aspect of one embodiment of the invention, the tap may be selectively extended and/or pulled out, from a retracted position within the bag, towards an extended position for pouring alcohol. The retracted position of the tap, within the bag, may preferably be adapted for shipping, storage, and/or to prevent customers' access.

According to an aspect of one preferred embodiment, the tap may be provided with a tamper-proof seal, which may be peeled off and/or away from the tap when ready for use. The tamper-proof seal may preferably be applied at the distillery and/or alcohol packaging facility and remain visibly intact until broken and/or removed by a customer, restaurant, bar and/or other establishment.

According to an aspect of one preferred embodiment, the bag or box may contain a potable alcoholic distillate, spirit, or liquor, or a prepared or “ready to drink” alcoholic cocktail or premixed drink. For prepared and “ready to drink” alcoholic cocktails and premixed drinks, the bag or box may preferably contain substantially about 3.0 Liters, and/or alternately substantially about 1.75 Liters, of any such cocktail or drink. For distillates, spirits, and liquors, the bag or box may preferably contain substantially about 1.0 Liters of any such distillate, spirit, or liquor for bars and restaurants (etc.) or for retail to consumers, and/or substantially about 1.75 Liters for retail to consumers. According to the invention, the bags and/or boxes may preferably contain a different volume of distillate, spirit, liquor, cocktail or alcoholic drink if and as may be prescribed by local laws and/or any applicable regulations.

According to an aspect of one preferred embodiment, a user may (A) break the seal on the tap and/or bag, (B) place the bag into an open countertop dispensing stand, and (C) extend the pouring spout of the tap through a hole on the front face of the stand.

According to an aspect of one preferred embodiment, the tap may have a sliding chamber. The chamber may preferably be sized to contain exactly 1 oz. (and/or 1.5 oz.) of fluid. The chamber preferably slides between a retracted filling position and an extended pouring position. The chamber has a top portion which may preferably be shaped to define one or more fill openings into the chamber from within the bag, preferably when the chamber is in the retracted filling position. Preferably, when the chamber is in the retracted filling position, the fluid within the bag may flow into the chamber through the fill openings.

According to an aspect of one preferred embodiment, the chamber may be slightly bottom-beveled to pour the alcohol out from the chamber, at least in part by gravity flow—for example, when one or more standard tabs on the tap squeezed. According to the invention, after the chamber has emptied, the user may preferably simply push the tap back into the bag for gravity refilling.

According to an aspect of one preferred embodiment, a user may (A) remove the tamper-proof/security seal from the bag and/or tap, (B) place a glass under the tap area, (C) pull and/or slide out the tap for substantially instantaneous pouring of alcohol from the chamber through the tap's spout, and (D) after the chamber has emptied, simply push the tap back into the bag for refilling, through the fill openings of the sliding chamber, and readying for the next pour.

According to an aspect of one preferred embodiment, after a bag has been emptied, it may simply be disposed of and/or replaced on the stand.

According to some embodiments of the invention, a countertop box may be provided as the stand or otherwise, and a lid may be provided on the countertop box, stand, or otherwise. In such embodiments, the user may preferably simply open and/or lift the lid and/or otherwise replace the bag when empty. Then, a new, different and/or full bag may preferably be inserted into the stand and/or box. The lid on the countertop box and/or on the stand may then be closed and the beverage fluid may be substantially ready to serve.

According to some embodiments of the invention, an interior shelf may be provided within the countertop box, stand, or otherwise. The bags may be placed and/or rest on the shelf when ready to serve.

According to an aspect of one preferred embodiment, a food grade plastic bag may be provided with a manual pour spout and/or tap for an alcoholic beverage. Preferably, after a short set-up, beverage fluid may flow through this spout and/or tap.

In some embodiments according to the invention, a user may manually hold down a top portion of the tap, while also pulling upward on two miniature tap paddles, to selectively allow the fluid to flow. In these embodiments, the fluid may then preferably flow until the user releases the top portion and/or tap paddles, thus to manually stop the fluid flow.

In some embodiments of the invention (e.g., for the home market), a constant flow tap may instead be provided on or for use with the disposable bag. In that case, after a user has removed the safety seal wrapper, the user may use the tap—for example, by pressing down on a top portion of the tap, while pulling up on flanking paddle handles—for a constant flow and/or pour until releasing tap.

According to an aspect of one preferred embodiment, however, the spout and/or tap according to the invention may only allow a single 1 oz. (or 1.5 oz.) to pour, at a time, before automatically stopping—unless and/or until the user repeats the process of pouring another such controlled quantity of fluid according to the invention.

According to an aspect of one embodiment, to pour a single 1 oz. (or 1.5 oz.) of fluid, the user may preferably (A) push down on the top cap of the tap while pulling up on one or more flanking paddles, (B) hold the tap in this manner until liquid automatically stops pouring, and (C) then release the tap. This process may preferably be repeated if and as may be desired and/or required.

According to an aspect of one preferred embodiment, a single push on the tap may dispense and/or pour an accurate and controlled single shot of beverage fluid each and every time it may be pushed.

According to the invention, there is also disclosed a system for use on a countertop to dispense at least one alcohol. The alcohol may preferably, but need not necessarily, be selected from the group consisting of potable alcoholic distillates, spirits, and liquors, prepared “ready to drink” alcoholic cocktails, and premixed alcoholic drinks. The system may preferably, but need not necessarily, include one or more containers, one or more metered taps, one or more tamper-proof seals, and/or a countertop dispensing stand.

Each of the containers may preferably, but need not necessarily, be selected from the group consisting of a bag and a box. Each of the containers is preferably shaped to define an internal reservoir that is adapted to contain the alcohol. Each of the containers may preferably, but need not necessarily, be formed from a food grade material. The food grade material may preferably, but need not necessarily, be a readily disposable, green, and/or recyclable material. The internal reservoir may preferably, but need not necessarily, contain between about 1.75 liters and about 3.0 liters when the alcohol is a prepared “ready to drink” alcoholic cocktail and/or a premixed alcoholic drink, and between about 1.0 liters and 1.75 liters when the alcohol is a potable alcoholic distillate, spirit, and/or liquor.

Each of the metered taps may preferably, but need not necessarily, have a pouring spout and securely engage a respective one of the containers for accurately dispensing, from the aforesaid internal reservoir, a predetermined volume of the alcohol in a controlled single pour from the pouring spout. The predetermined volume is preferably either one ounce (1 oz.) or one-and-a-half ounces (1.5 oz.). Each of the metered taps is preferably adapted to accurately pour the predetermined volume with substantial precision. Each of the metered taps may preferably, but need not necessarily, be selectively movable between a retracted configuration and an extended configuration. Each of the metered taps in the retracted configuration may preferably, but need not necessarily, be located within the aforesaid respective one of the containers and adapted for shipping and storage. In the extended configuration, the pouring spout may preferably, but need not necessarily, be extended and pulled out relative to the retracted configuration, and adapted for pouring the alcohol.

Each of the metered taps may preferably, but need not necessarily, have a sliding section. The sliding section may preferably, but need not necessarily, be shaped to define an internal chamber sized to contain the predetermined volume with the aforesaid substantial precision. The sliding section may preferably, but need not necessarily, have a top portion that is shaped to define one or more fill openings into the internal chamber. In the retracted configuration, the sliding section may preferably, but need not necessarily, be located within the aforesaid respective one of the containers and the alcohol flows from the internal reservoir into the internal chamber through the fill openings. The sliding section may preferably, but need not necessarily, have a bottom portion with a downwards incline, inside the internal chamber, toward the pouring spout. In the extended configuration, (i) the sliding section may preferably, but need not necessarily, be extended and pulled out relative to the retracted configuration, (ii) the sliding section may preferably, but need not necessarily, block the aforesaid flow of the alcohol from the internal reservoir through the fill openings, and/or (iii) when the pouring spout is selectively actuated, the downwards incline inside the internal chamber may preferably, but need not necessarily, dispense the alcohol from the internal chamber at least in part by gravity flow.

The pouring spout may preferably, but need not necessarily, have a top spout portion and two flanking paddles. The pouring spout may preferably, but need not necessarily, be selectively actuated as aforesaid, to empty the internal chamber, by pulling up on the flanking paddles while holding down top spout portion. In the extended configuration, after the internal chamber has emptied, the sliding section may preferably, but need not necessarily, block further flow of alcohol from the pouring spout.

Each one of the tamper-proof seals may preferably, but need not necessarily, be applied to and securely seal the aforesaid respective one of the containers or a respective one of the metered taps. The tamper-proof seals may preferably, but need not necessarily, be applied at an alcohol packaging facility. Each of the tamper-proof seals may preferably, but need not necessarily, remain visibly intact when securely sealing as aforesaid. Each of the tamper-proof seals may preferably, but need not necessarily, be frangible and selectively removable when ready for use.

The countertop dispensing stand is preferably adapted to securely receive and hold each of the containers in a substantially upright dispensing configuration. The countertop dispensing stand may preferably, but need not necessarily: (i) be constructed from one or more substantially durable materials, with (ii) the substantially durable materials including a commercial grade corrugated plastic material; (iii) be adapted for disposal and/or recycling after use over a season and/or at one or more events; (iv) include divider inserts that define container sections, one for each of the containers, in the countertop dispensing stand, with each of the container sections preferably holding a single one of the containers; (v) have a front face that is shaped to define one or more open holes therethrough, one for each of the metered taps, with the pouring spout of each of the metered taps preferably extending, in the extended configuration, through a respective one of the open holes; (vi) have a drip tray located underneath the metered taps; and/or (vii) have legs to engage the countertop and keep the metered taps about two inches (2″) above the countertop.

The containers may preferably, but need not necessarily, be selectively receivable within, and selectively removable from, the countertop dispensing stand.

The containers and the countertop dispensing stand may preferably, but need not necessarily, be together adapted to afford users with an unobstructed line of sight on the containers when securely received and held by the countertop dispensing stand.

The aforesaid one or more containers may preferably, but need not necessarily, include four such containers. The aforesaid one or more metered taps may preferably, but need not necessarily, include four such metered taps. The countertop dispensing stand may preferably, but need not necessarily, securely receive and hold the four containers. The countertop dispensing stand may preferably, but need not necessarily, be adapted to support about 8.0 pounds (about 3.7 kilograms) of weight in the aforesaid containers.

According to an aspect of one preferred embodiment, each of the metered taps may preferably, but need not necessarily, be selectively removable from its respective one of the containers.

According to an aspect of one preferred embodiment, each of the metered taps may preferably, but need not necessarily, be integrally attached to its respective one of the containers and together provided as a single-piece construction.

According to an aspect of one preferred embodiment, each of the containers may preferably, but need not necessarily, have a front face. Each of the metered taps may preferably, but need not necessarily, extend from the front face of its respective one of the containers.

According to an aspect of one preferred embodiment, each of the containers may preferably, but need not necessarily, have a side end. Each of the metered taps may preferably, but need not necessarily, extend from the side end of its respective one of the containers.

According to the invention, there is also disclosed a method of using the aforesaid system. The method preferably includes the steps of: (a) breaking and removing one of the tamper-proof seals as aforesaid; (b) placing and receiving the aforesaid respective one of the containers within the countertop dispensing stand; (c) placing a glass under the aforesaid respective one of the open holes in the front face of the countertop dispensing stand; (d) pulling out and extending the aforesaid respective one of the metered taps towards the extended configuration, such that the pouring spout preferably extends through the aforesaid respective one of the open holes for pouring the alcohol from the internal chamber into the glass; and (e) after the internal chamber has emptied, pushing the aforesaid respective one of the metered taps back into the aforesaid respective one of the containers and into the retracted configuration for refilling the internal chamber for a next said controlled single pour.

According to the invention, there is also disclosed a metered tap. The metered tap is adapted to securely engage a container that has an internal reservoir containing alcohol. The metered tap includes a pouring spout and a sliding section. The metered tap is preferably adapted to accurately dispense, from the internal reservoir, a predetermined volume of the alcohol in a controlled single pour from the pouring spout. The predetermined volume is preferably one ounce (1 oz.) or one-and-a-half ounces (1.5 oz.). The metered tap is preferably adapted to accurately pour the predetermined volume with substantial precision. The metered tap may preferably, but need not necessarily, be selectively movable between a retracted configuration and an extended configuration. In the retracted configuration, the metered tap may preferably, but need not necessarily, be adapted to be located within the container. In the extended configuration, the pouring spout may preferably, but need not necessarily, be extended and pulled out relative to the retracted configuration, and adapted for pouring the alcohol. The sliding section may preferably, but need not necessarily, be shaped to define an internal chamber that is preferably sized to contain the predetermined volume with the aforesaid substantial precision. The sliding section may preferably, but need not necessarily, have a top portion that is preferably shaped to define one or more fill openings into the internal chamber. In the retracted configuration, the sliding section may preferably, but need not necessarily, be adapted to be located within the container, preferably such that the alcohol flows from the internal reservoir into the internal chamber through the fill openings. In the extended configuration, the sliding section may preferably, but need not necessarily, be (i) extended and pulled out relative to the retracted configuration, and/or (ii) adapted to block the aforesaid flow of the alcohol from the internal reservoir through the fill openings. Preferably, (iii) when the pouring spout is selectively actuated, the alcohol is dispensed and empties from the internal chamber at least in part by gravity flow. In the extended configuration, after the internal chamber has emptied, the sliding section may preferably, but need not necessarily, be adapted to block further flow of the alcohol from the pouring spout.

According to an aspect of one preferred embodiment, the sliding section may preferably, but need not necessarily, have a bottom portion with a downwards incline, inside the internal chamber, toward the pouring spout. In the extended configuration when the pouring spout is selectively actuated, the downwards incline inside the internal chamber may preferably, but need not necessarily, dispense the alcohol from the internal chamber at least in part by gravity flow as aforesaid.

According to an aspect of one preferred embodiment, the pouring spout may preferably, but need not necessarily, have a top spout portion and two flanking paddles. The pouring spout may preferably, but need not necessarily, be selectively actuated as aforesaid, to empty the internal chamber, by pulling up on the flanking paddles while holding down top spout portion.

According to an aspect of one preferred embodiment, the metered tap may preferably, but need not necessarily, be adapted to be selectively removable from the container.

Other advantages, features and characteristics of the present invention, as well as methods of operation and functions of the related elements of the structure, and the combination of parts and economies of manufacture, will become more apparent upon consideration of the following detailed description with reference to the figures which accompany this application.

### BRIEF DESCRIPTION OF THE DRAWINGS

The novel features which are believed to be characteristic of the present invention, and related devices, systems, and methods according to the present invention, as to their structure, organization, use and method of operation, together with further objectives and advantages thereof, may be better understood from the figures which accompany this application in which presently preferred embodiments of the invention are illustrated by way of example. It is expressly understood, however, that such figures are for the purpose of illustration and description only, and not intended as a definition of the limits of the invention. In the accompanying drawings:

FIG. 1 are front and side elevational views of a tap having a one ounce chamber according to a preferred embodiment of the invention;

FIG. 2 are front top right side perspective views of the tap of FIG. 1 in extended and retracted configurations;

FIG. 3 are front and right side elevational views of the tap of FIG. 1 shown in use with a bag according to first and second steps of the invention;

FIG. 4 are front and left side elevational views of the tap of FIG. 1 shown in use with a bag according to third and fourth steps of the invention;

FIG. 5 is a top, front, right perspective view of a design for the alcohol bag according to the invention, shown without the tap;

FIG. 6 is a front elevational view thereof;

FIG. 7 is a back elevational view thereof;

FIG. 8 are right and left side elevational views thereof;

FIG. 9 are top and bottom plan views thereof;

FIG. 10 is a top, front, right perspective view thereof, showing the tap according to the invention;

FIG. 11 are front and right side elevational views of an alternate bag according to the invention, with the tap on the right side thereof;

FIG. 12 is a rear left side perspective view of a tap and chamber according to an alternate embodiment of the invention;

FIG. 13 are right side and front elevational views of the bag and tap of FIGS. 11 and 12 shown in use together according to first, second, third, and fourth steps of the invention;

FIG. 14 are front and side elevational views of a tap, similar to that shown in FIG. 1, according to another preferred embodiment of the invention;

FIG. 15 are right side elevational views of a bag and tap shown in use together according to first, second, and third steps of an another preferred embodiment of the invention;

FIG. 16 are views of a prior art food grade disposable bag with a prior art flow tap;

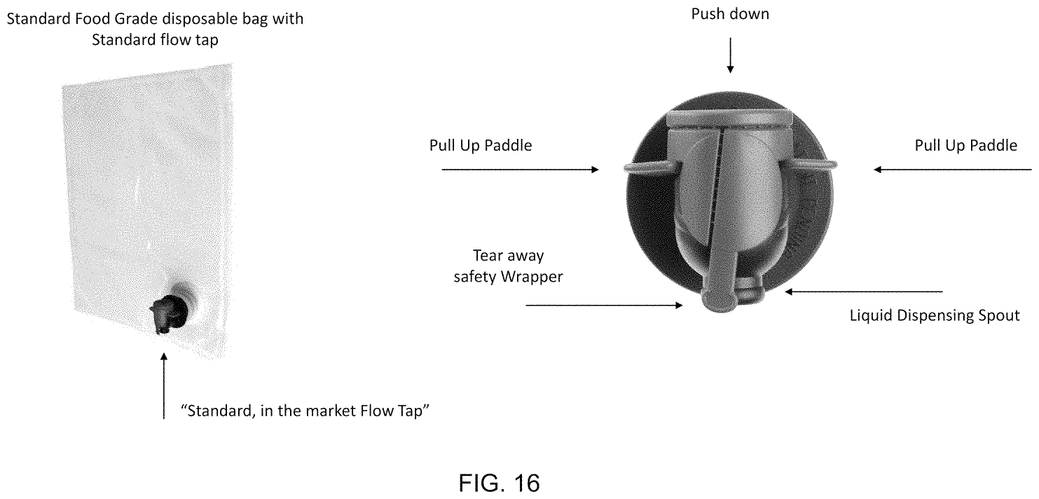

FIG. 17 are views of a food grade disposable bag with a tap according to a preferred embodiment of the invention;

FIG. 18 is a front elevational view of another preferred tap according to the invention, shown dispensing a measured one ounce (1 oz.) pour before automatically stopping;

FIG. 19 are front and side elevational views of the tap of FIG. 18;

FIG. 20 are front elevational views of two different stands, shown together with bags having taps on the right side thereof, according to further preferred embodiments of the invention;

FIG. 21 are front elevational views of two different stands, shown together with bags having taps on the front thereof, according to yet further preferred embodiments of the invention;

FIG. 22 are front elevational views of the two stands shown in FIG. 20 or 21;

FIG. 23 are front elevational views of the two stands, before connection of a distinctive signage component, shown in FIG. 22;

FIG. 24 are front elevational views of the two stands of FIG. 23, shown with exemplary dimensions for the stands shown in FIG. 21;

FIG. 25 are front elevational views of the two stands of FIG. 23, shown with exemplary dimensions for the stands shown in FIG. 22;

FIG. 26 are top plan views of the two stands of FIG. 23;

FIG. 27 is a front elevational view of one stand from FIG. 23, shown with dimensions for the tap center above an underlying substrate surface;

FIG. 28 is a front elevational view of one stand from FIG. 20, shown before a bag is placed thereon;

FIG. 29 is a left side elevational view of the stands of FIG. 20, shown with exemplary dimensions, according to one preferred embodiment of the invention;

FIG. 30 is a left side elevational view of the stands of FIG. 21, shown with exemplary dimensions, according to one preferred embodiment of the invention;

FIG. 31 is a top front right side perspective view of one of the stands of FIG. 25;

FIG. 32 is a top front right side perspective view of one of the stands of FIG. 21;

FIG. 33 is a top front right side perspective view of the stand of FIG. 32, shown with a bag placed thereon;

FIG. 34 is a front elevational view of the stand of FIG. 31;

FIG. 35 is a front elevational view of the stand of FIG. 32;

FIG. 36 is a rear elevational view of the stand of FIG. 31;

FIG. 37 is a rear elevational view of the stand of FIG. 32;

FIG. 38 are right and left side elevational views of the stand of FIG. 31;

FIG. 39 are right and left side elevational views of the stand of FIG. 32;

FIG. 40 are top and bottom plan views of the stand of FIG. 31;

FIG. 41 are top and bottom plan views of the stand of FIG. 32;

FIG. 42 are a front left side perspective view and a front view of a box, with a tap, according to another preferred embodiment of the invention;

FIG. 43 is a top, back, left perspective view of a design for a prepared alcoholic cocktail and mixed drink box according to alternate embodiments of the invention;

FIG. 44 is a top, front, right perspective view thereof;

FIG. 45 is a right side elevational view thereof;

FIG. 46 is a left side elevational view thereof;

FIG. 47 are front and back elevational views thereof; and

FIG. 48 are bottom and top plan views thereof.

### DETAILED DESCRIPTION OF PREFERRED EMBODIMENTS

This disclosure, including the accompanying drawings, may include one or more dimensions and/or may or may not be drawn to scale and, in any event, are illustrated by way of example. It may bear repeating, in this respect specifically, that such drawings and/or disclosures are for the purpose of illustration and description only, and not intended as a definition of the limits of the invention.

Additionally, one or more of the directional terms (e.g., front, top, bottom, left, right, side) or other terms used herein, and in the accompanying drawings, may be otherwise regarded and/or referenced using other terms.

Still further, the teachings and disclosures herein with respect to the food grade disposable bag, having a 1 oz. (or 1.5 oz.) tap for pouring alcohol, for use with a countertop dispensing stand may apply equally well, mutatis mutandis, with respect instead to a box (in place of the bag). In such embodiments, a bag may be situated within the box, and the box may be perforated and the tap extended from within the box into a pouring configuration. Alternately, the box may otherwise be provided with the tap which has been disclosed and taught elsewhere herein. And, for example, the word “box” may indicates a structure that, elsewhere herein, may be regarded or referenced as a bag.

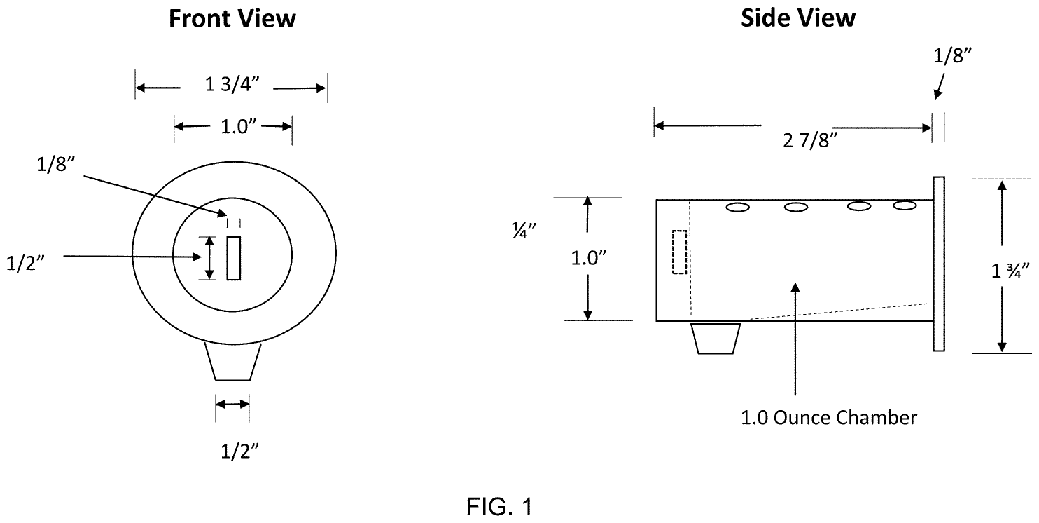

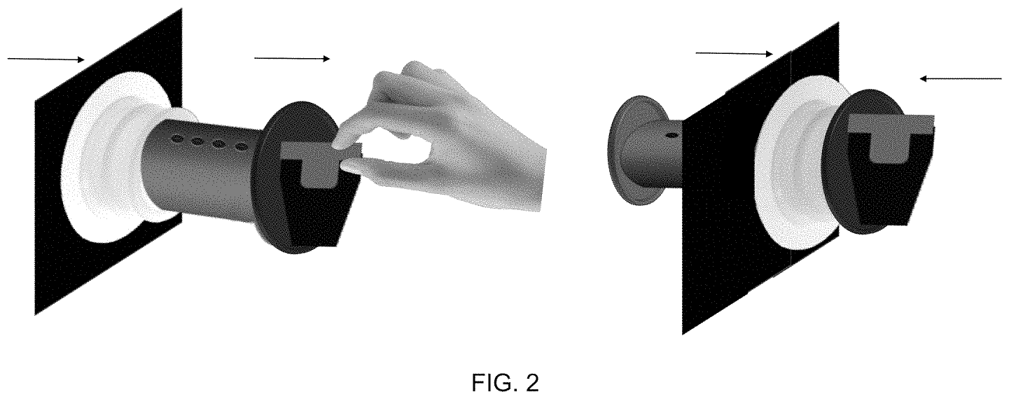

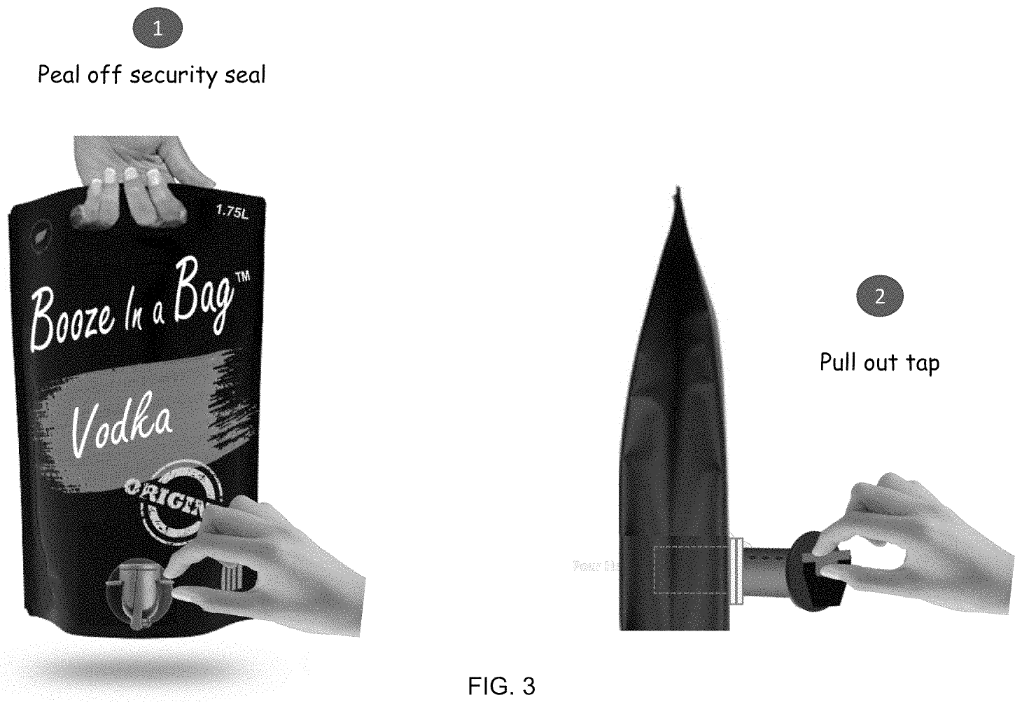

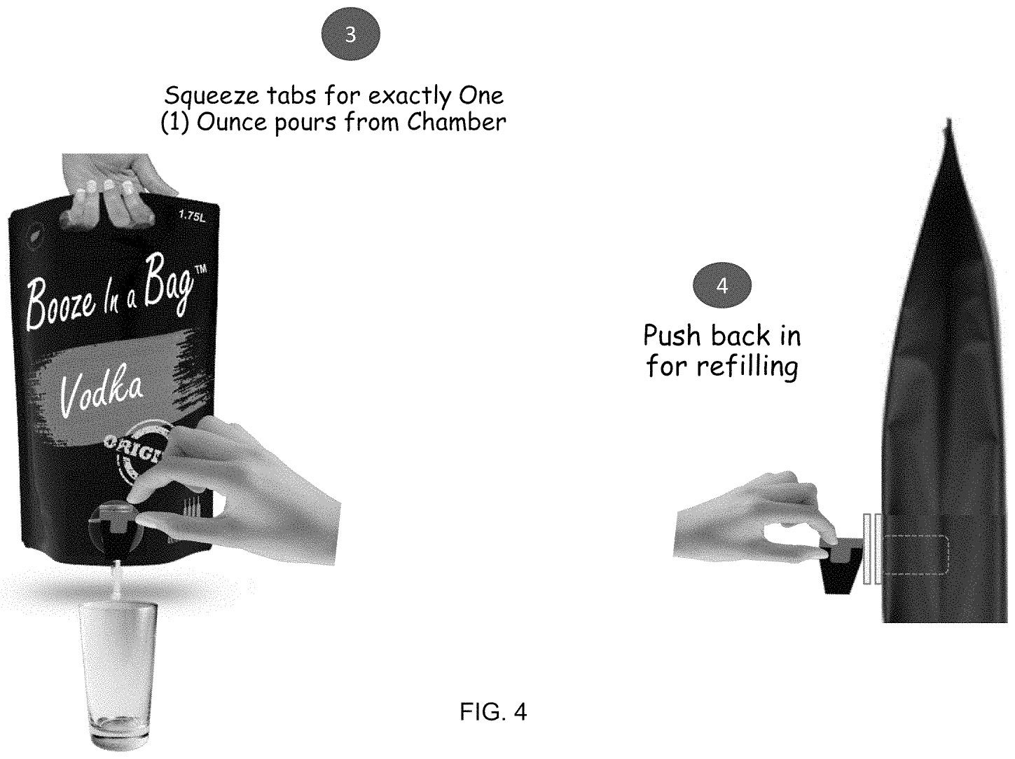

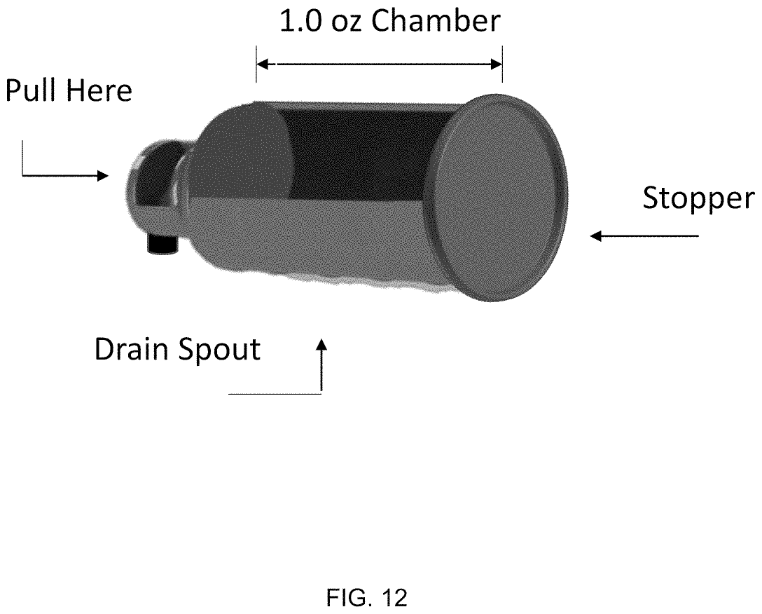

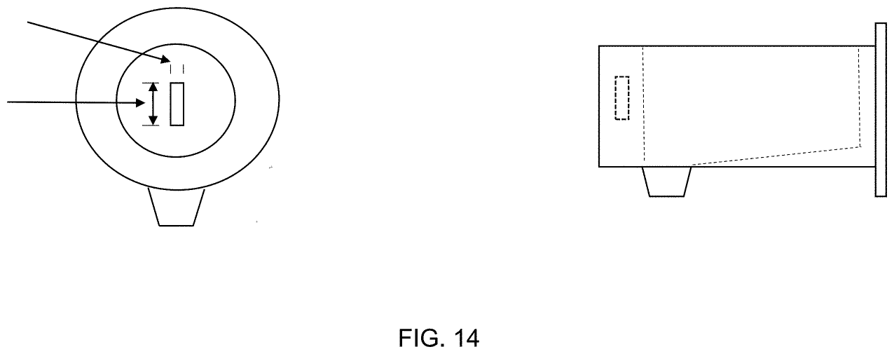

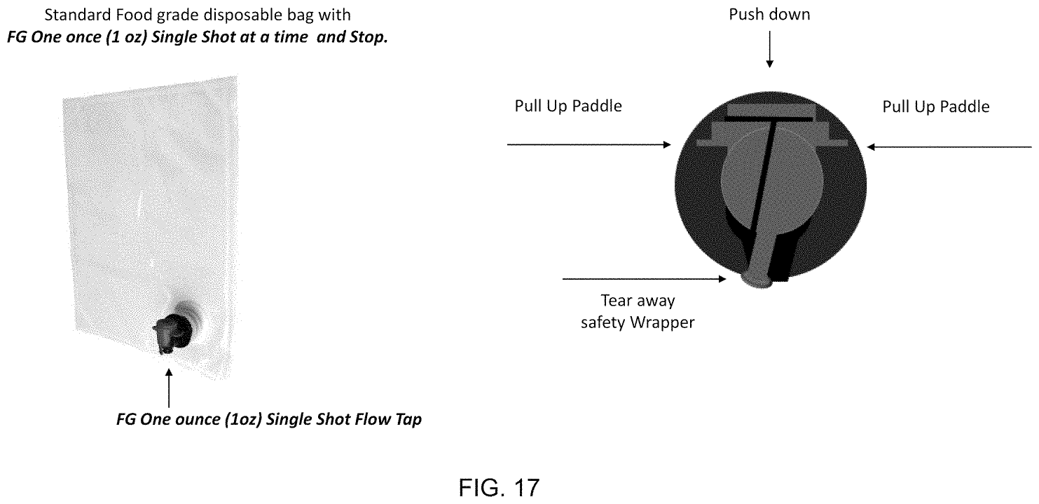

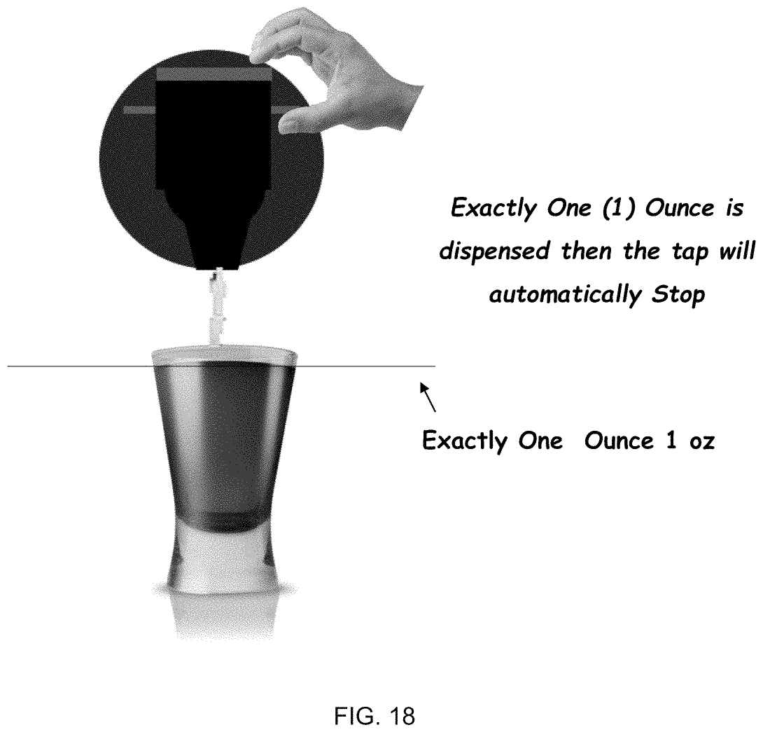

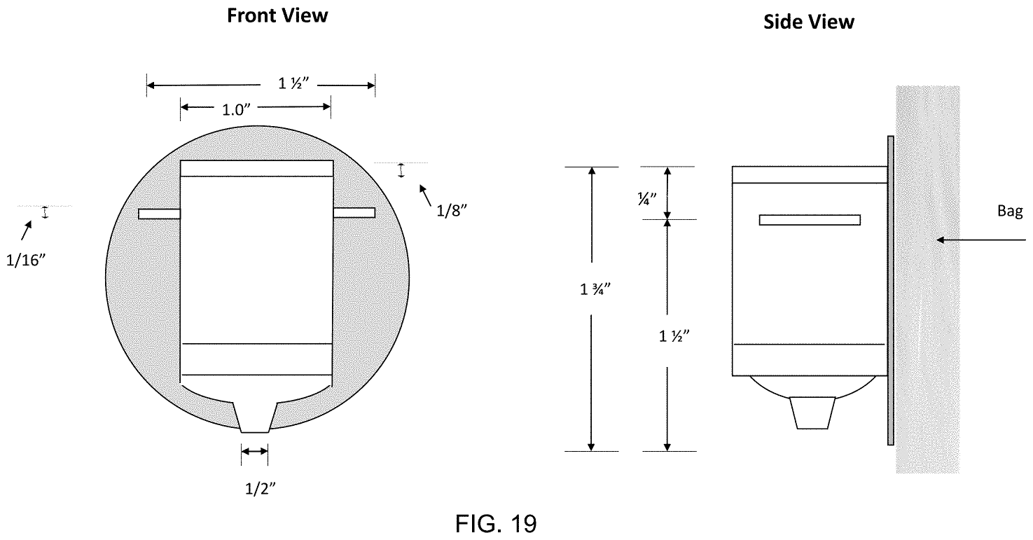

As shown in FIGS. 1, 12, 14, and 17 to 19, according to preferred embodiments of the invention, a tap has a one ounce chamber. As shown in FIGS. 2 to 4, the tap may be moved between extended and retracted configurations to pour the beverage fluid.

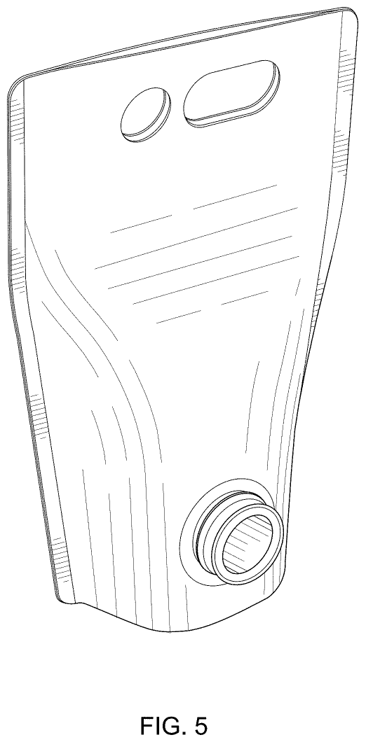

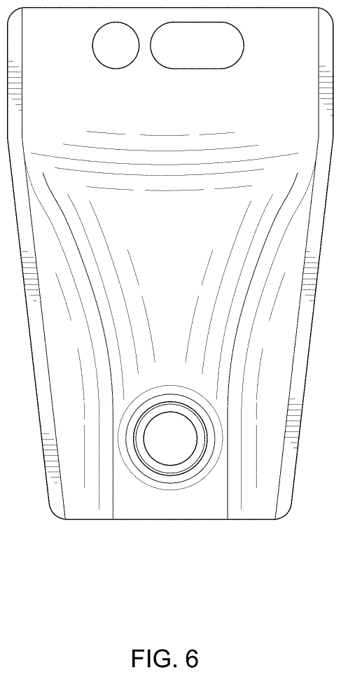

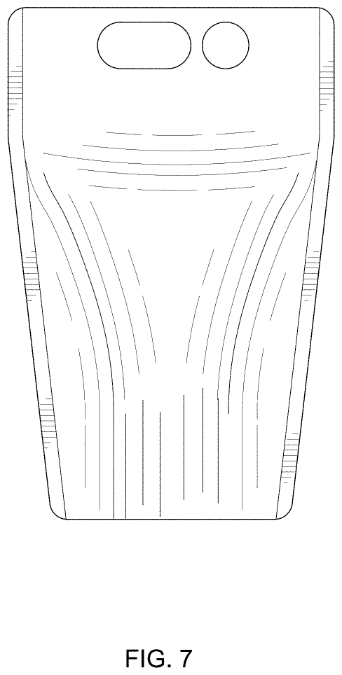

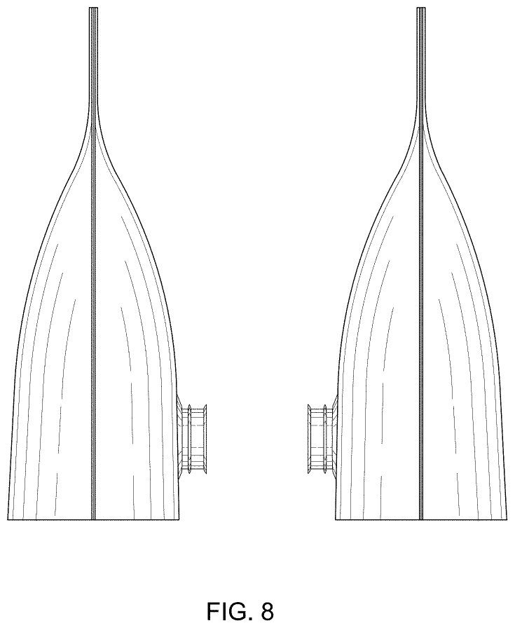

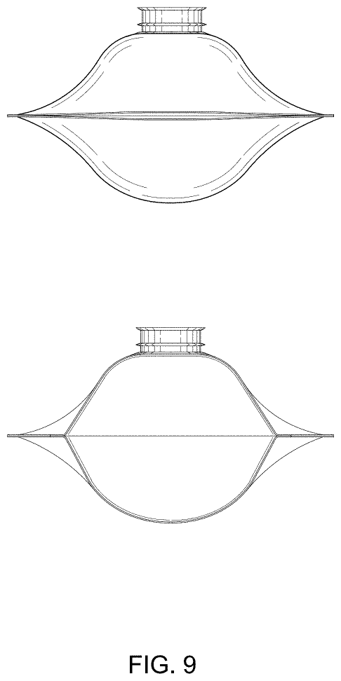

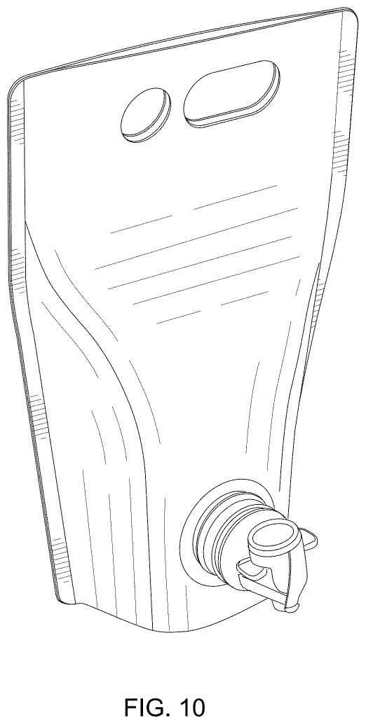

FIGS. 5 to 9 show one preferred bag, according to the invention, which has a port on the front thereof in fluid communication with the tap (not shown). The tap is instead shown in place on the bag, according to the invention, in FIG. 10.

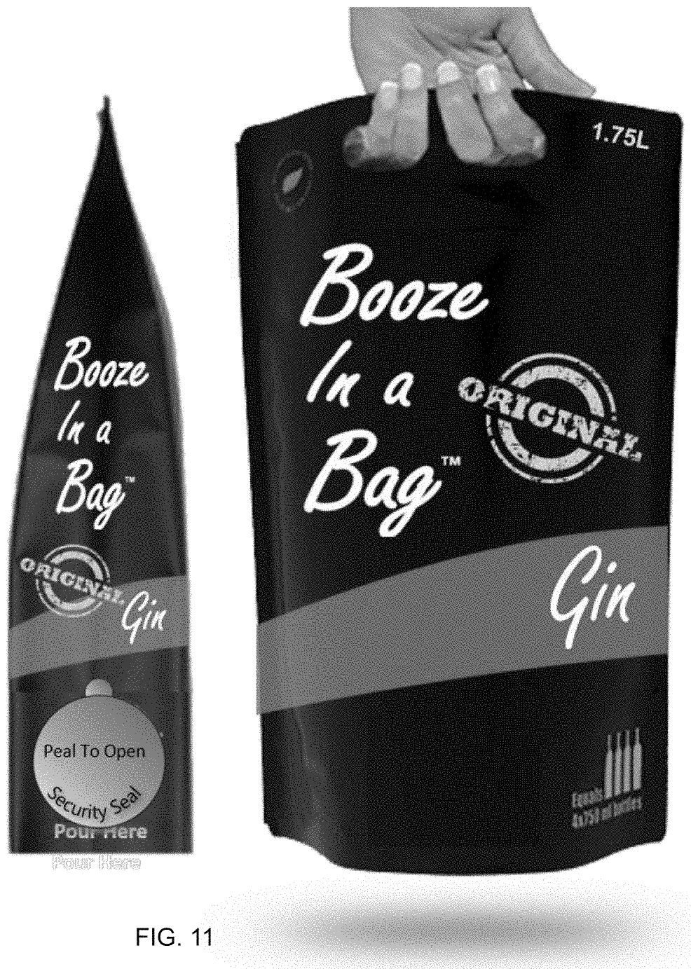

As shown in the drawings (and best seen in FIG. 11) the bag preferably has a handle for readily carrying, moving, and placing the bag if and where may be desired or required.

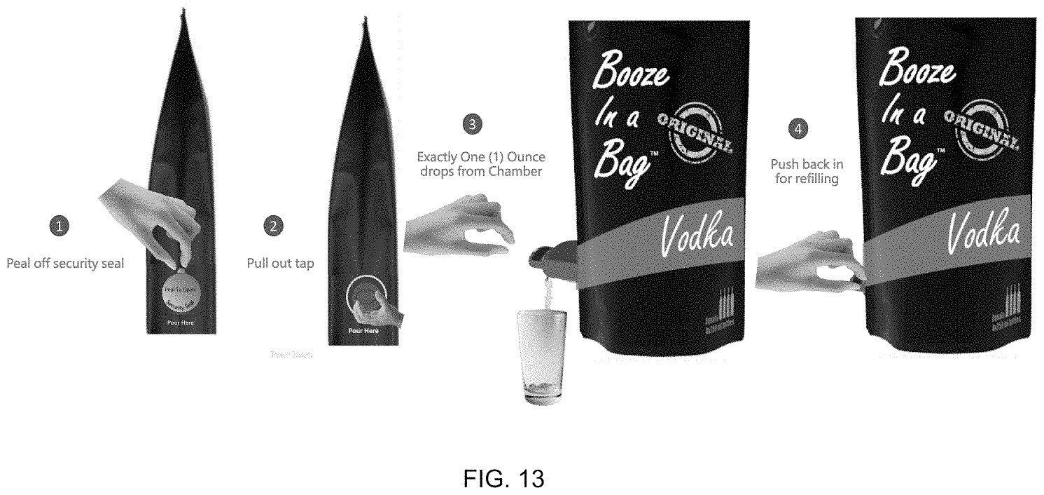

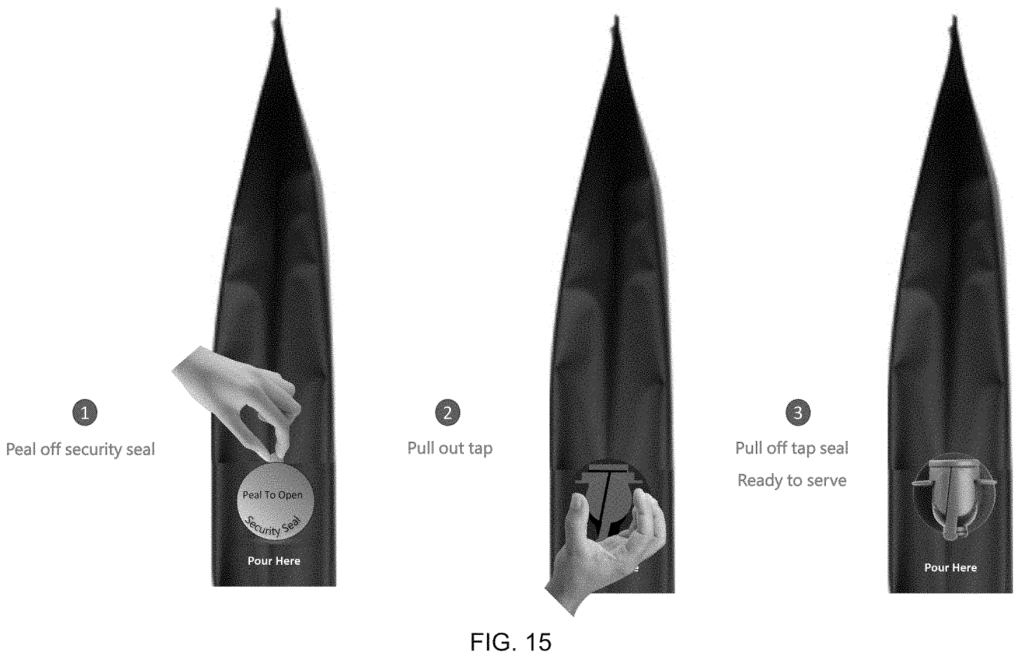

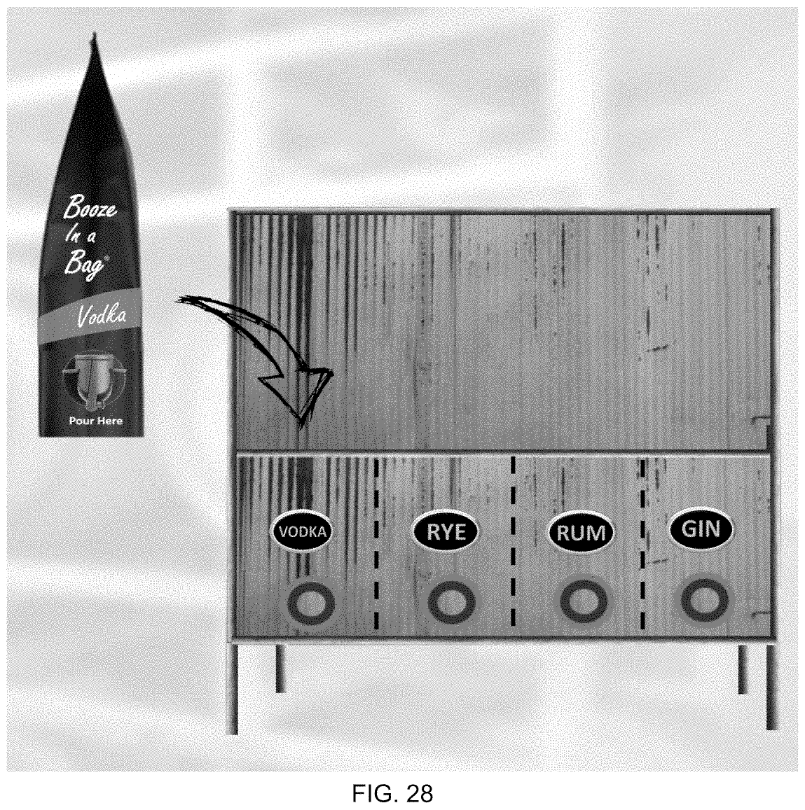

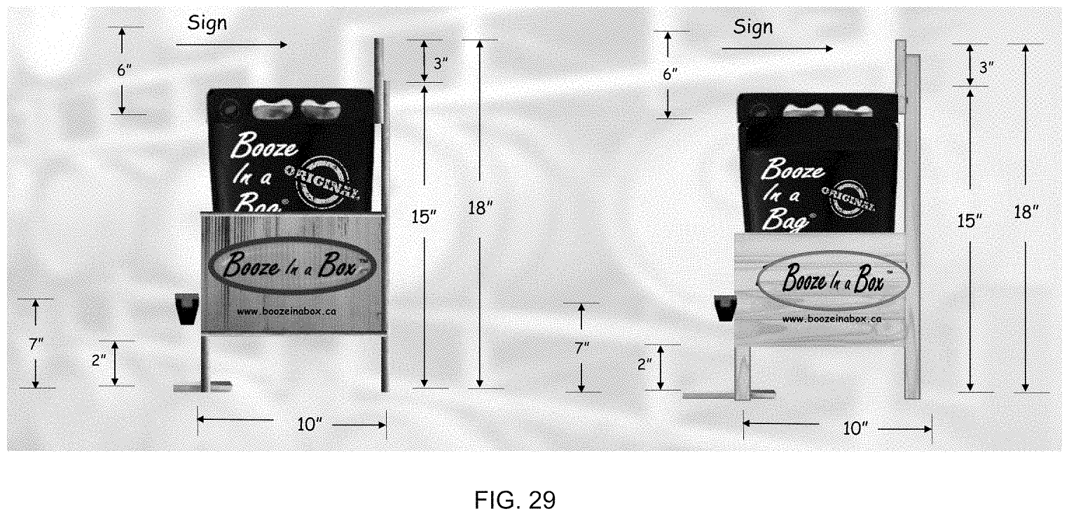

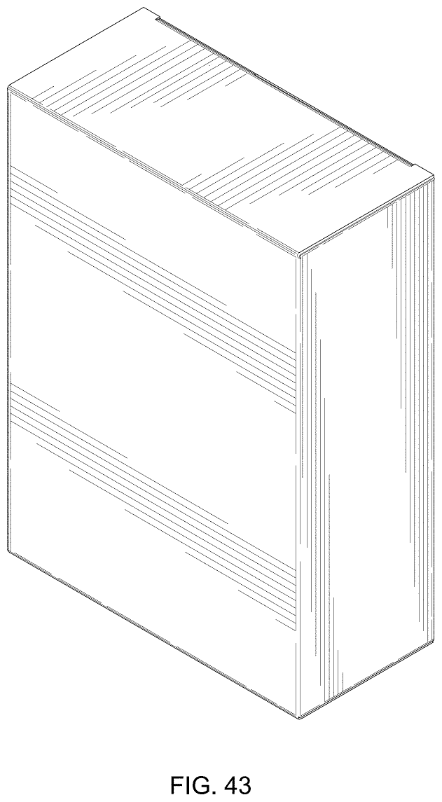

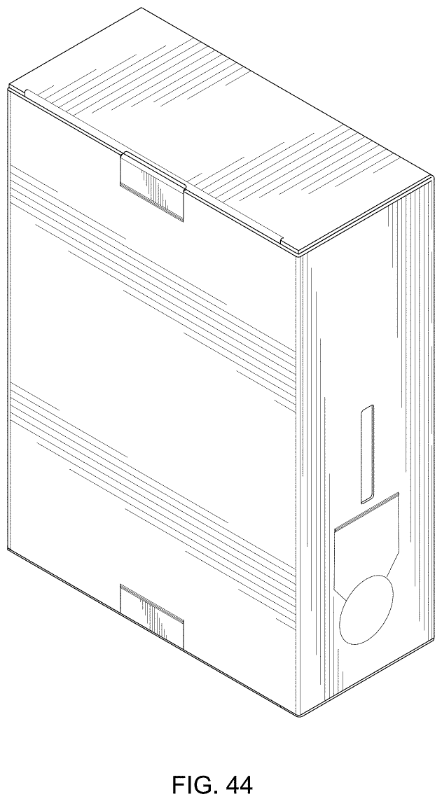

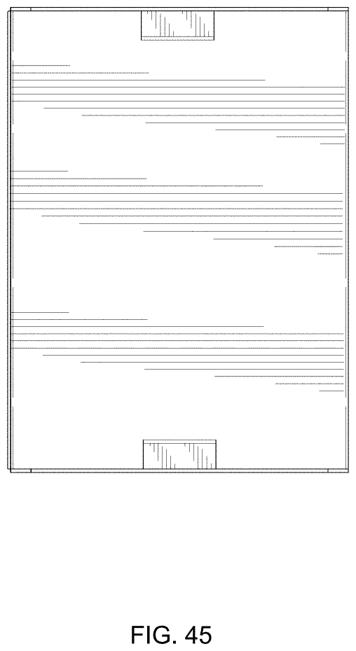

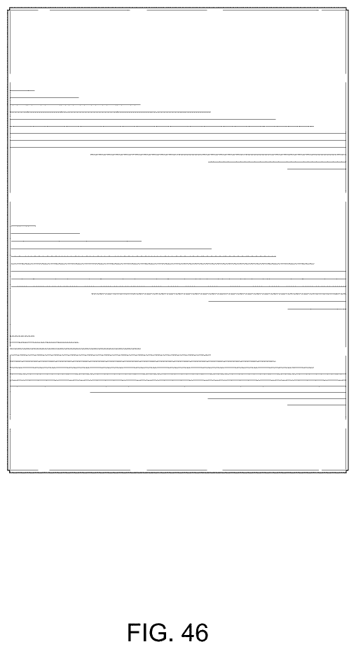

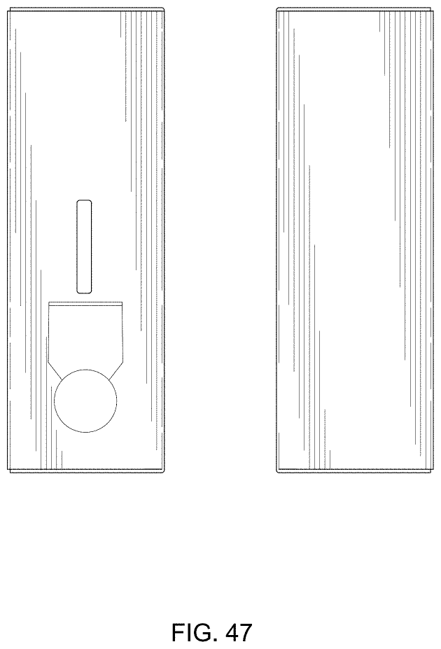

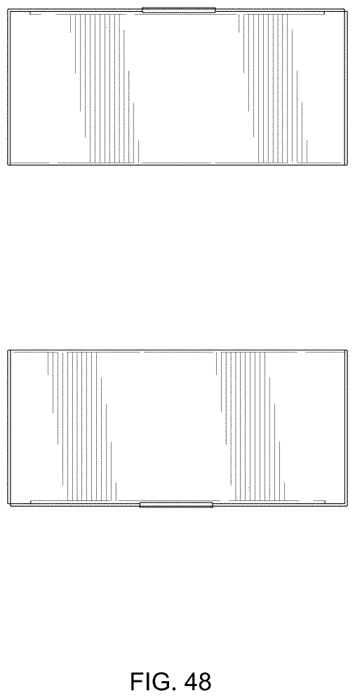

Alternately, as shown in FIGS. 11, 13, 15, 20, 28, 29 and 42 to 48, the bag (or box) may have the tap on the side thereof, instead of on its front.

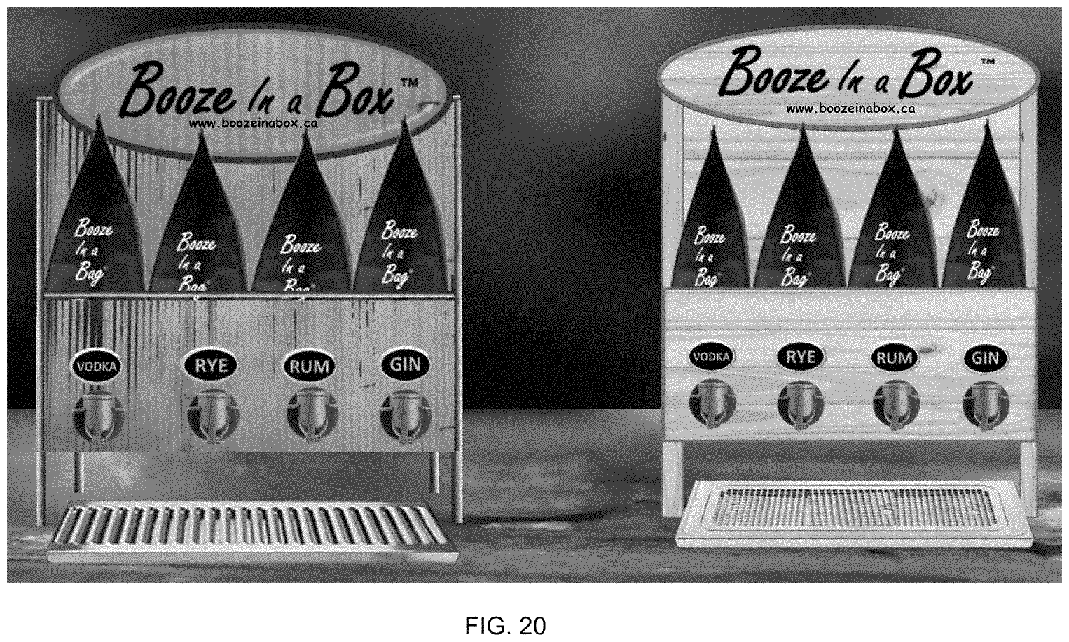

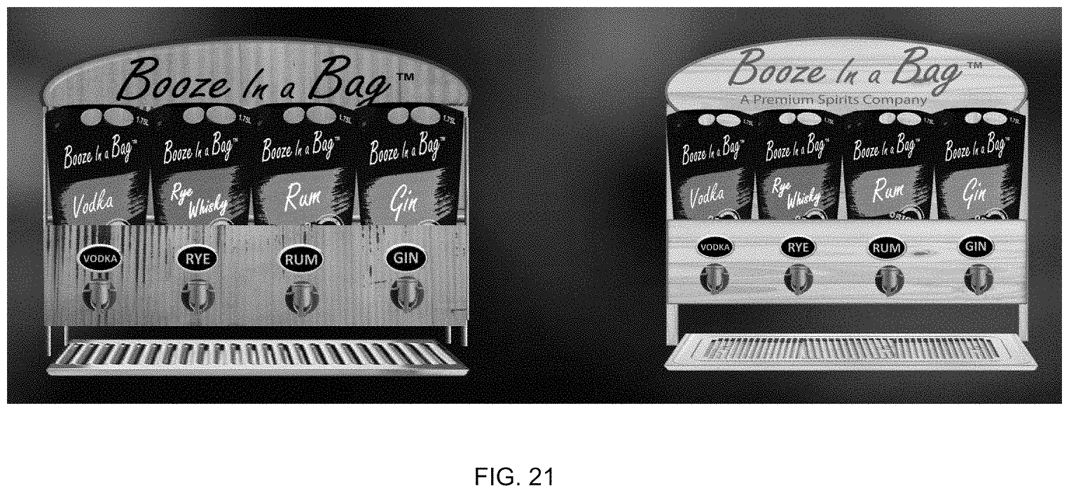

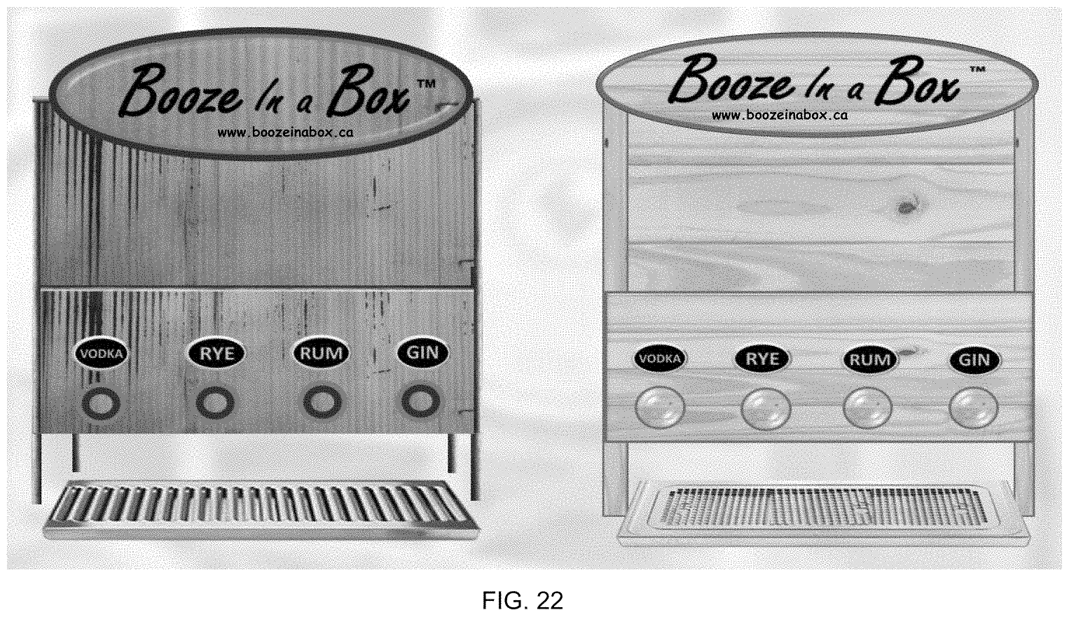

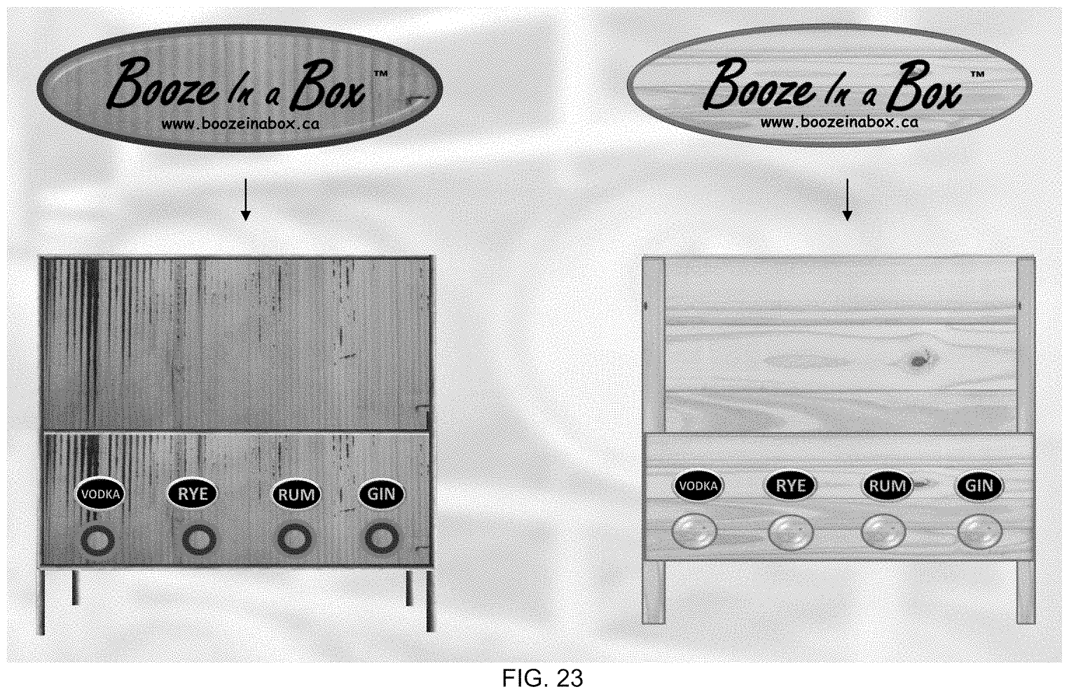

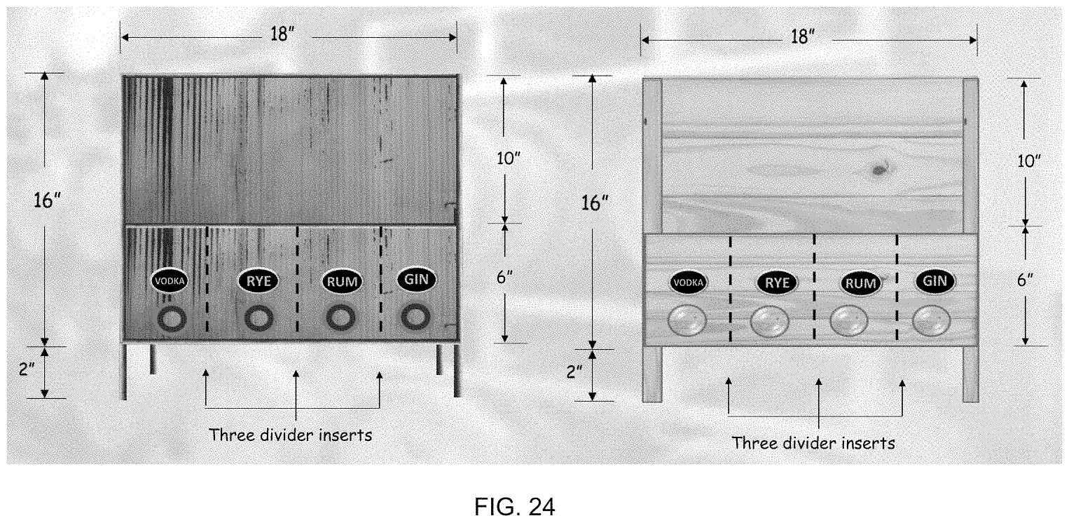

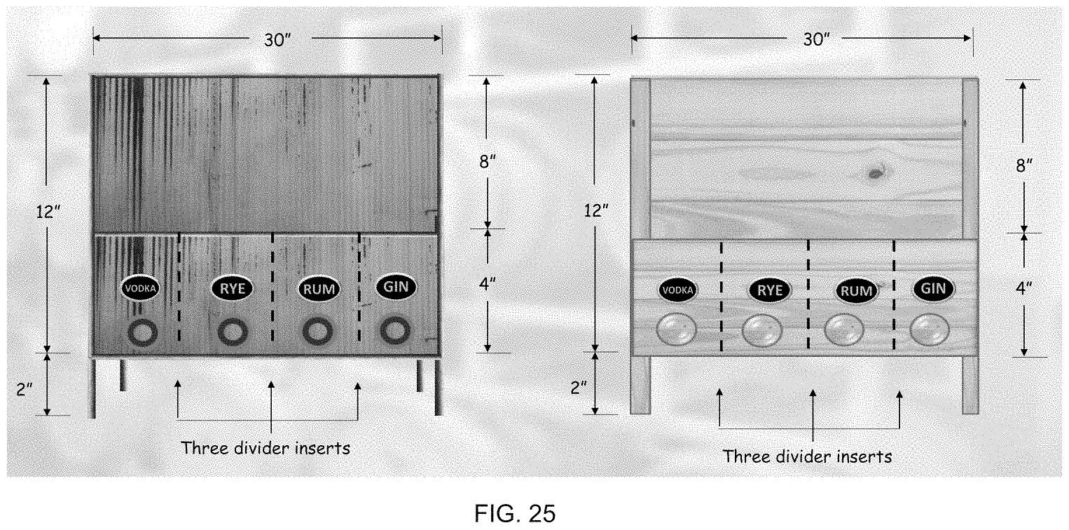

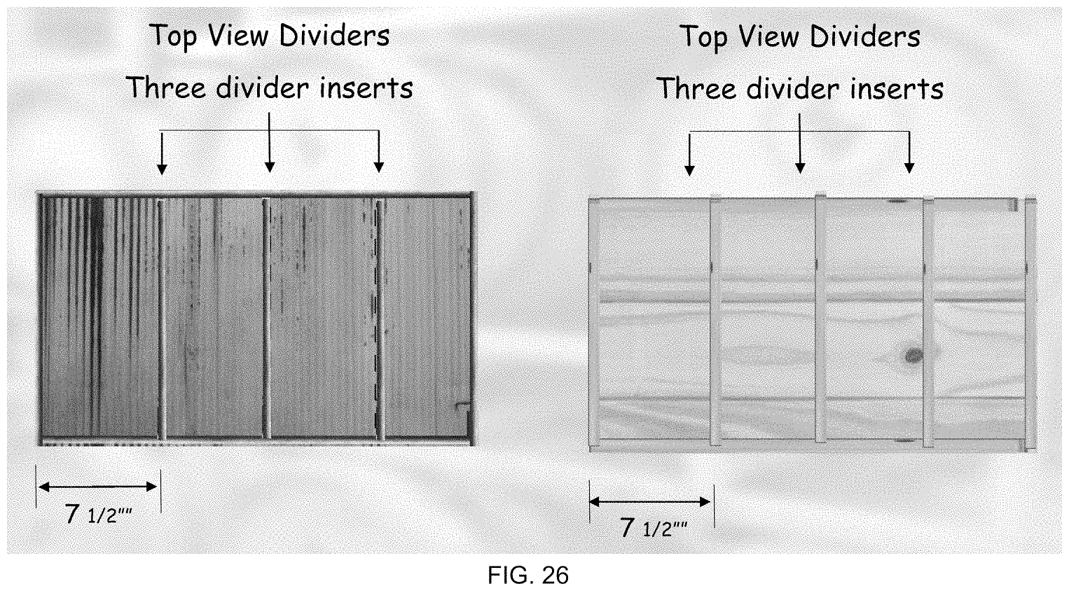

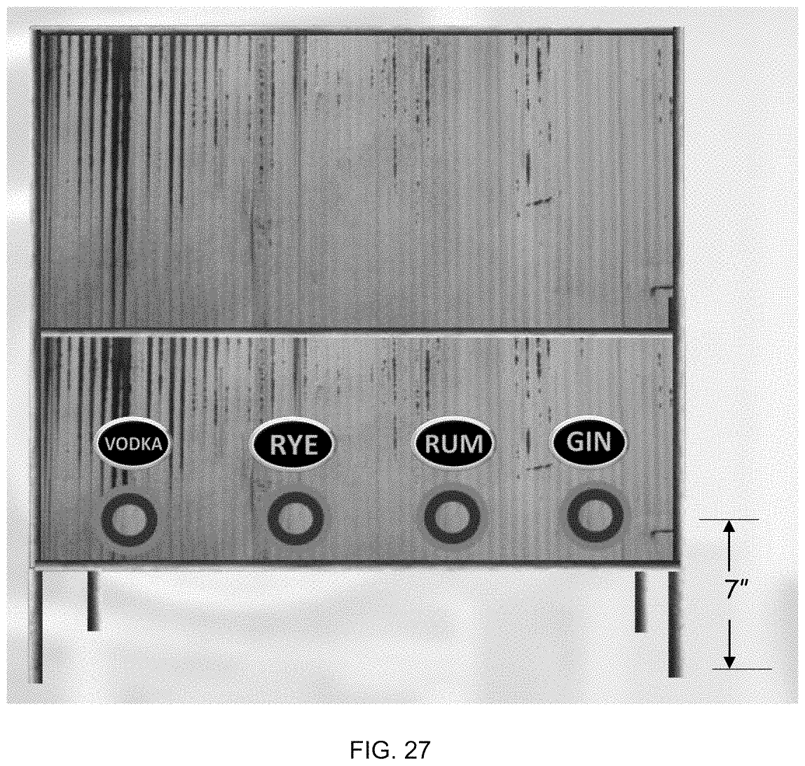

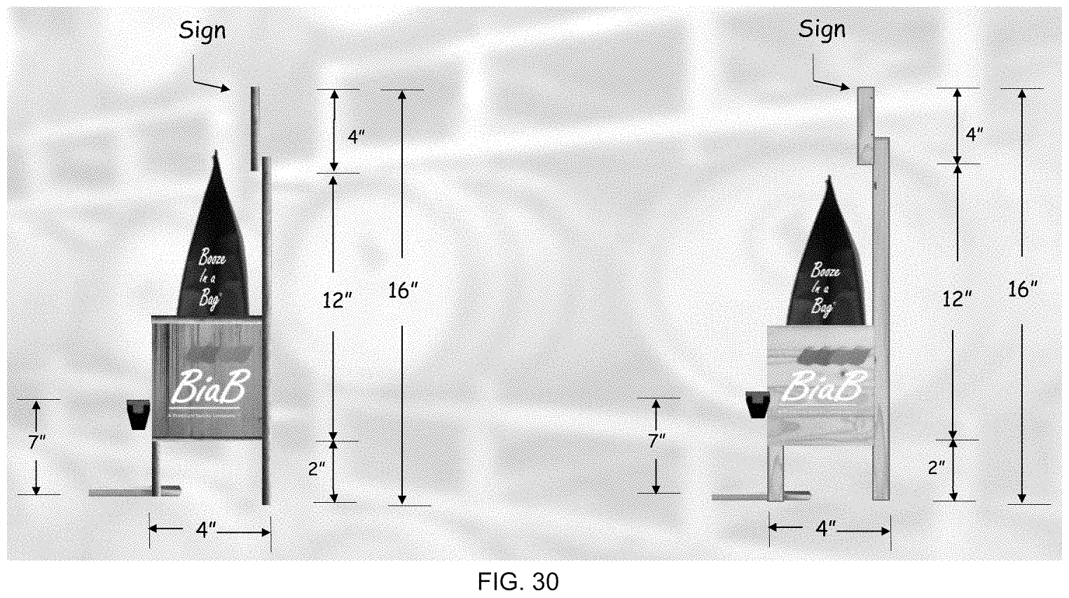

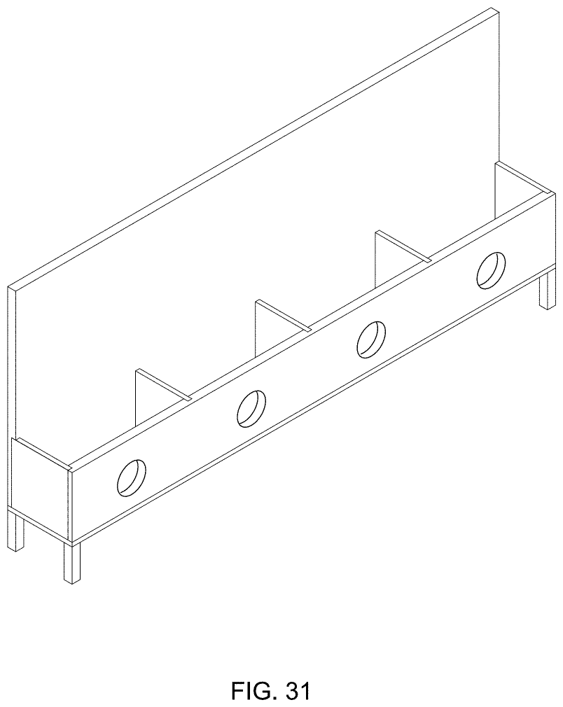

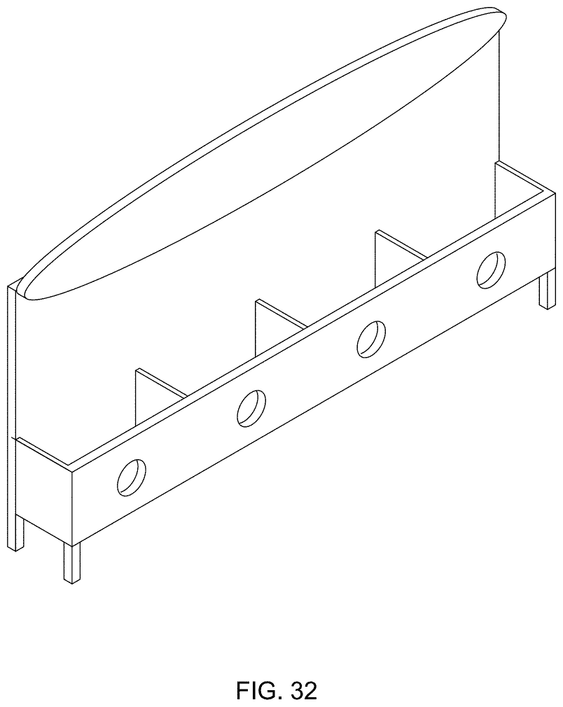

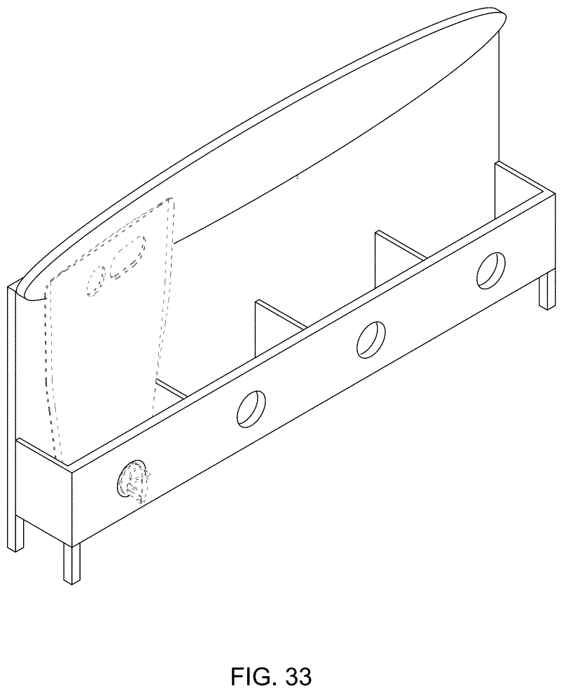

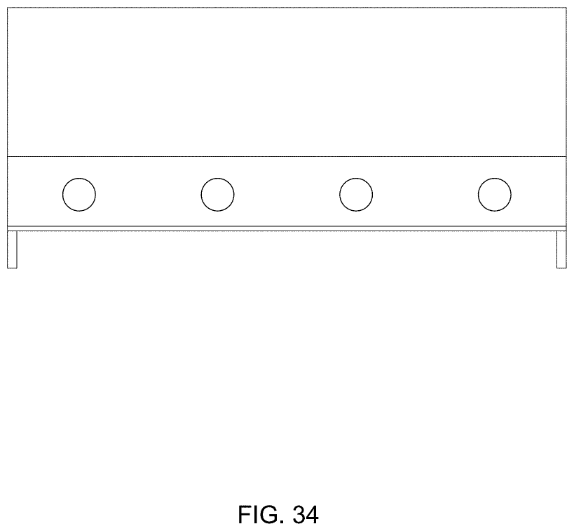

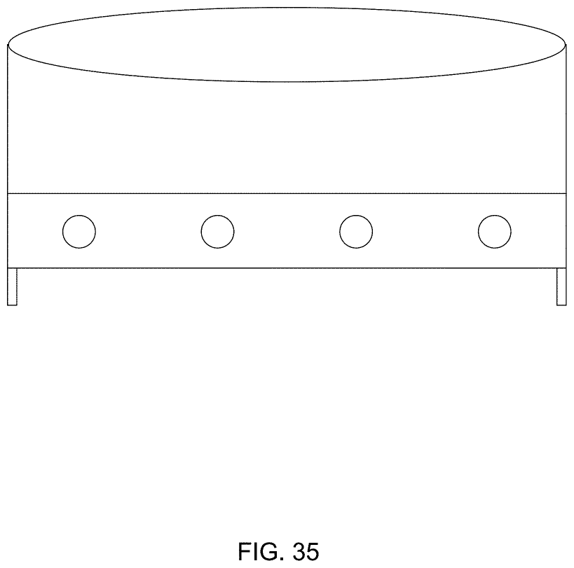

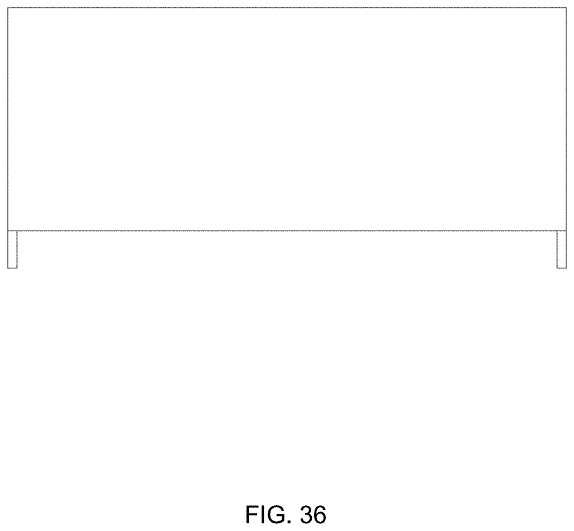

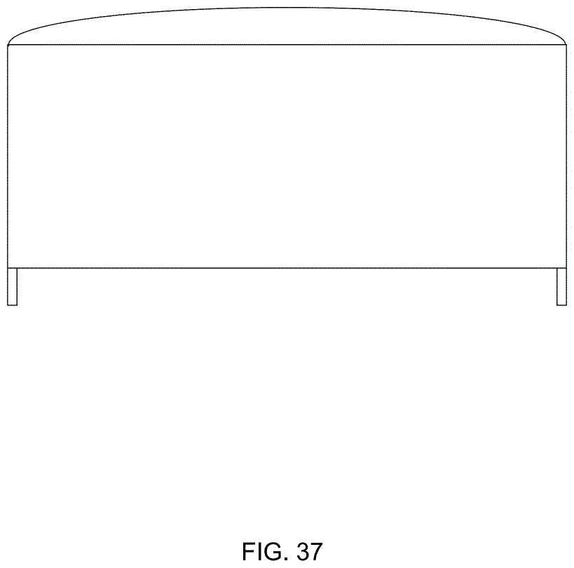

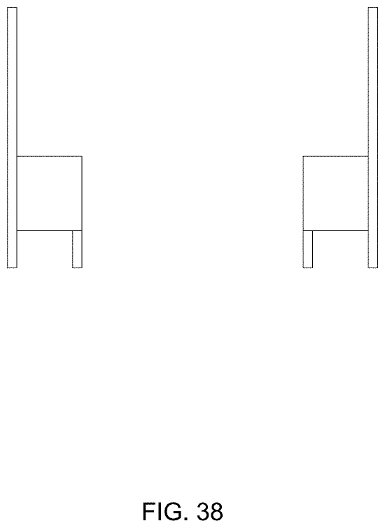

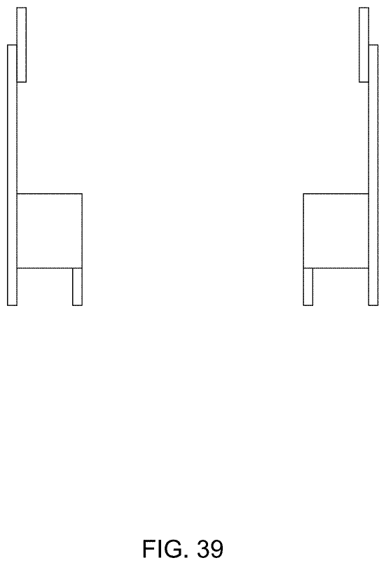

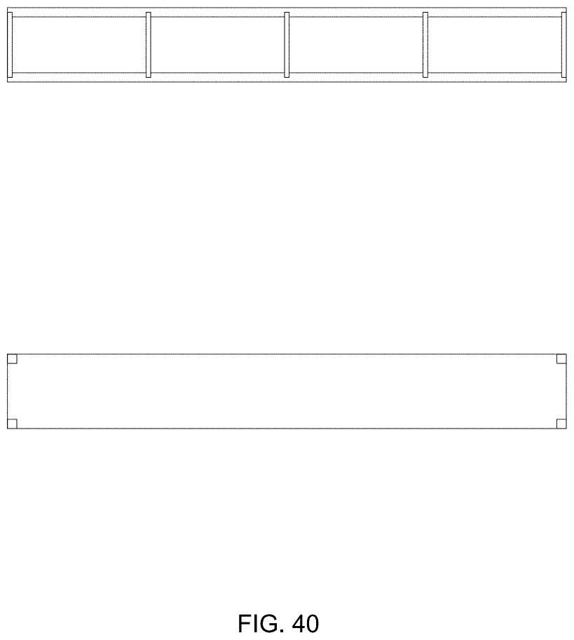

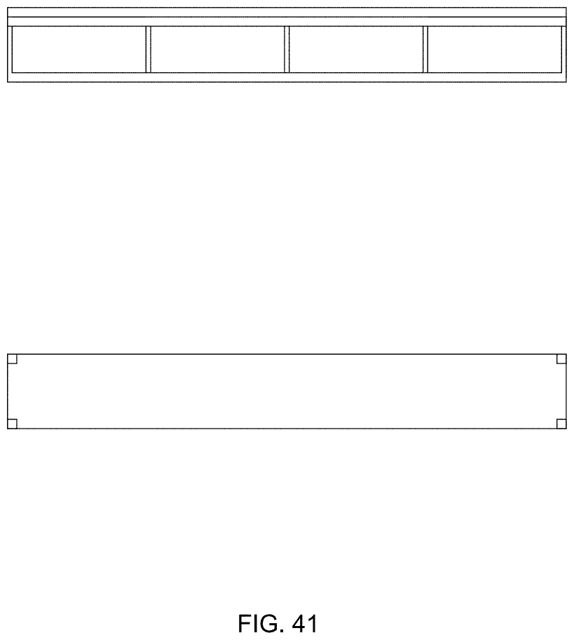

As shown in FIGS. 20 to 41, the stand may preferably be adapted to accommodate the bags, whether their taps are on the front or side thereof. As best seen in FIG. 23, the stand may be provided with an upper stand display surface (as shown in FIGS. 20 to 22, 29, 30, 32, 33, 35, 37, 39, and 41) or without it (as shown in FIGS. 24 to 28, 31, 34, 36, 38, and 40).

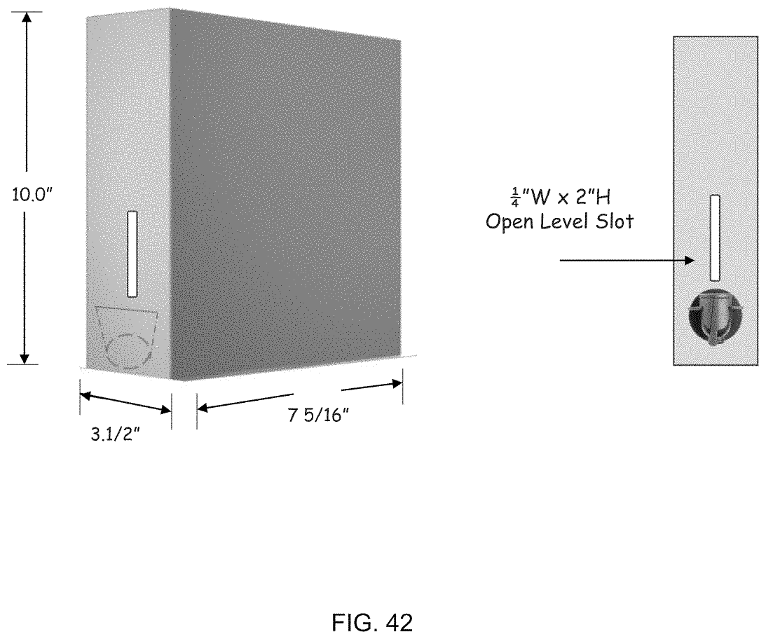

FIGS. 42 to 48 show a box which may be provided according to one or more alternately preferred embodiments of the invention. As shown in FIGS. 42, 44 and 47, the box preferably includes a level window slot, so a user may readily gauge the amount of beverage fluid remaining therein.

The system according to the invention is preferably for use on a countertop to dispense alcohol. The system preferably includes four containers, four metered taps, four tamper-proof seals, and a countertop dispensing stand.

Each container is preferably a bag or a box. Each preferably has an internal reservoir that contains alcohol. Each is preferably formed from a food grade material that is readily disposable, green, and/or recyclable. The internal reservoir preferably contains either: between 1.75 liters and 3.0 liters of a prepared “ready to drink” alcoholic cocktail or a premixed alcoholic drink; or between 1.0 liters and 1.75 liters of a potable alcoholic distillate, spirit, or liquor.

Each metered tap preferably has a pouring spout and securely engages one container for accurately dispensing, from its internal reservoir, a predetermined volume of the alcohol in a controlled single pour from the pouring spout. The predetermined volume is preferably either one ounce (1 oz.) or one-and-a-half ounces (1.5 oz.). Each metered tap preferably accurately pours the predetermined volume with substantial precision. Each metered tap is preferably selectively movable between a retracted configuration and an extended configuration. Each metered tap, in the retracted configuration, is preferably located within the container and adapted for shipping and storage. In the extended configuration, the pouring spout is preferably extended and pulled out relative to the retracted configuration, and adapted for pouring the alcohol.

Each metered tap preferably has a sliding section. The sliding section preferably has an internal chamber precisely sized to contain the predetermined volume. The sliding section preferably has a top portion with fill openings therethrough into the internal chamber. In the retracted configuration, the sliding section is preferably located within the container and the alcohol flows from the internal reservoir into the internal chamber through the fill openings. The sliding section preferably has a bottom portion with a downwards incline, inside the internal chamber, toward the pouring spout. Preferably, in the extended configuration, (i) the sliding section is extended and pulled out relative to the retracted configuration, (ii) the sliding section blocks the flow of the alcohol from the internal reservoir through the fill openings, and (iii) when the pouring spout is selectively actuated, the downwards incline inside the internal chamber dispenses the alcohol from the internal chamber by gravity flow.

The pouring spout preferably has a top spout portion and two flanking paddles. The pouring spout can preferably be selectively actuated as aforesaid, to empty the internal chamber, by pulling up on the flanking paddles while holding down top spout portion. In the extended configuration, after the internal chamber has emptied, the sliding section preferably blocks further flow of alcohol from the pouring spout.

The tamper-proof seal is preferably applied to and securely seals the container and/or the metered tap. The tamper-proof seal is preferably applied at an alcohol packaging facility. The tamper-proof seal preferably remains visibly intact when securely sealing the container and/or the metered tap as aforesaid. The tamper-proof seal is preferably frangible and selectively removable from the container and/or the metered tap when ready for use.

The countertop dispensing stand is preferably adapted to securely receive and hold the four containers, each in a substantially upright dispensing configuration. The countertop dispensing stand preferably: (i) is constructed from a substantially durable materials, such as (ii) a commercial grade corrugated plastic material; (iii) adapted for disposal and/or recycling after use over a season and/or at one or more events; (iv) includes three divider inserts that define four container sections, one for each of the four containers, in the countertop dispensing stand, with each of the four container sections preferably holding a single one of the four containers; (v) has a front face with four open holes therethrough, one for each of the four metered taps, with the pouring spout of each of the metered taps preferably extending, in the extended configuration, through one of the open holes; (vi) has a drip tray located underneath the metered taps; and (vii) has legs to engage the countertop and keep the metered taps about two inches (2″) above the countertop.

The four containers preferably are selectively receivable within, and selectively removable from, the countertop dispensing stand.

The containers and the countertop dispensing stand together preferably afford users with an unobstructed line of sight on the four containers when securely received and held by the countertop dispensing stand.

The countertop dispensing stand preferably supports about 8.0 pounds (about 3.7 kilograms) of weight in the four containers.

The metered tap is preferably selectively removable from the container. But, in some preferred embodiments, the metered tap may be integrally attached to the container and together provided as a single-piece construction.

The metered tap preferably extends from a front face of the container. But, in some preferred embodiments, the metered tap may extend from a side end of the container.

In a method according to the present invention, the user preferably breaks and removes the tamper-proof seals from the containers and/or taps as aforesaid, and places the four containers within the countertop dispensing stand. The user then places a glass under one of the open holes in the front face of the countertop dispensing stand, and pulls out and extends the corresponding metered tap towards its extended configuration. As such, the pouring spout preferably extends through the open hole for pouring the alcohol from the internal chamber into the glass. After the internal chamber has emptied, the user pushes the metered tap back into the container and into the retracted configuration for refilling the internal chamber for the next controlled single pour.

The invention is contemplated for use in association with a food grade disposable bag or a box, having a 1 oz. (or 1.5 oz.) tap for pouring alcohol, for use with a countertop dispensing stand to afford increased advantageous utilities in association with same. The invention, however, is not so limited. Other embodiments, which fall within the scope of the invention, may be provided.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations and/or steps according to the invention are not specifically referenced in association with one another, they may be used, and/or adapted for use, in association therewith. For example, features may be discussed herein in the context of the device, which clearly could be recast as steps of a method and/or as the interworking of a system. All of the aforementioned and various other features, steps, interworkings, structures, configurations, relationships, utilities, and/or the like (any of which may be depicted and/or based hereon) may be, but are not necessarily, incorporated into and/or achieved by the invention. Any one or more of the aforementioned features, steps, interworkings, structures, configurations, relationships, utilities and the like may be implemented in and/or by the invention, on their own, and/or without reference, regard or likewise implementation of any of the other aforementioned features, steps, interworkings, structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims hereof.

1. A system for use on a countertop to dispense at least one alcohol selected from the group consisting of potable alcoholic distillates, spirits, and liquors, prepared “ready to drink” alcoholic cocktails, and premixed alcoholic drinks, the system comprising:
one or more containers, each selected from the group consisting of a bag and a box, each of the containers shaped to define an internal reservoir that is adapted to contain the alcohol, wherein each of the containers is formed from a food grade material, wherein the food grade material is a readily disposable, green, and/or recyclable material; wherein the internal reservoir is adapted to contain between about 1.75 liters and about 3.0 liters when the alcohol is selected from the group consisting of prepared “ready to drink” alcoholic cocktails and premixed alcoholic drinks, and between about 1.0 liters and 1.75 liters when the alcohol is selected from the group consisting of potable alcoholic distillates, spirits, and liquors;
one or more metered taps, each having a pouring spout and securely engaging a respective one of the containers for accurately dispensing from said internal reservoir a predetermined volume of the alcohol in a controlled single pour from the pouring spout; wherein the predetermined volume is selected from the group consisting of one ounce (1 oz.) and one-and-a-half ounces (1.5 oz.); wherein each of the metered taps is adapted to accurately pour the predetermined volume with substantial precision; wherein each of the metered taps is selectively movable between a retracted configuration and an extended configuration; wherein, in the retracted configuration, each of the metered taps is located within its said respective one of the containers and adapted for shipping and storage; wherein, in the extended configuration, the pouring spout is extended and pulled out relative to the retracted configuration, and adapted for pouring the alcohol;
wherein each of the metered taps has a sliding section; wherein the sliding section is shaped to define an internal chamber sized to contain the predetermined volume with the aforesaid substantial precision; wherein the sliding section has a top portion that is shaped to define one or more fill openings into the internal chamber; wherein, in the retracted configuration, the sliding section is located within said respective one of the containers and the alcohol flows from the internal reservoir into the internal chamber through the fill openings; wherein the sliding section has a bottom portion with a downwards incline, inside the internal chamber, toward the pouring spout;
wherein, in the extended configuration: the sliding section is extended and pulled out relative to the retracted configuration, the sliding section blocks the aforesaid flow of the alcohol from the internal reservoir through the fill openings and, when the pouring spout is selectively actuated, the downwards incline inside the internal chamber dispenses the alcohol from the internal chamber at least in part by gravity flow;
wherein the pouring spout has a top spout portion and two flanking paddles; wherein the pouring spout is selectively actuated as aforesaid, to empty the internal chamber, by pulling up on the flanking paddles while holding down top spout portion; and wherein in the extended configuration, after the internal chamber has emptied, the sliding section blocks further flow of alcohol from the pouring spout;
one or more tamper-proof seals, one each applied to and securely sealing the group consisting of said respective one of the containers and a respective one of the metered taps; wherein the tamper-proof seals are applied at an alcohol packaging facility; wherein each of the tamper-proof seals remains visibly intact when securely sealing as aforesaid; wherein each of the tamper-proof seals is frangible and selectively removable when ready for use; and
a countertop dispensing stand adapted to securely receive and hold each of the containers in a substantially upright dispensing configuration; and wherein the countertop dispensing stand: (i) is constructed from one or more substantially durable materials, and (ii) the substantially durable materials comprise a commercial grade corrugated plastic material; (iii) is adapted for disposal and/or recycling after use over a season and/or at one or more events; (iv) comprises divider inserts that define container sections, one for each of the containers, in the countertop dispensing stand, with each of the container sections holding a single one of the containers; (v) has a front face that is shaped to define one or more open holes therethrough, one for each of the metered taps, with the pouring spout of each of the metered taps extending, in the extended configuration, through a respective one of the open holes; (vi) has a drip tray located underneath the metered taps; and (vii) has legs to engage the countertop and keep the metered taps about two inches (2″) above the countertop;
wherein the containers are selectively receivable within, and selectively removable from, the countertop dispensing stand;
wherein the containers and the countertop dispensing stand are together adapted to afford users with an unobstructed line of sight on the containers when securely received and held by the countertop dispensing stand; and
wherein said one or more containers comprise four said containers, said one or more metered taps comprise four said metered taps, and the countertop dispensing stand securely receives and holds the four said containers, and wherein the countertop dispensing stand is adapted to support about 8.0 pounds (about 3.7 kilograms) of weight in said containers.

2. A system according to claim 1, wherein each of the metered taps is selectively removable from its respective one of the containers.

3. A system according to claim 1, wherein each of the metered taps is integrally attached to its respective one of the containers and together provided as a single-piece construction.

4. A system according to claim 1, wherein each of the containers has a front face, and each of the metered taps extends from the front face of its respective one of the containers.

5. A system according to claim 1, wherein each of the containers has a side end, and each of the metered taps extends from the side end of its respective one of the containers.

6. A method of using the system according to claim 1, comprising the steps of: (a) breaking and removing one of the tamper-proof seals as aforesaid; (b) placing and receiving said respective one of the containers within the countertop dispensing stand; (c) placing a glass under the said respective one of the open holes in the front face of the countertop dispensing stand; (d) pulling out and extending said respective one of the metered taps towards the extended configuration, such that the pouring spout extends through said respective one of the open holes for pouring the alcohol from the internal chamber into the glass; and (e) after the internal chamber has emptied, pushing said respective one of the metered taps back into said respective one of the containers and into the retracted configuration for refilling the internal chamber for a next said controlled single pour.

7. A metered tap, for securely engaging a container that has an internal reservoir containing alcohol, the metered tap comprising:
a pouring spout, wherein the metered tap is adapted to accurately dispense from the internal reservoir a predetermined volume of the alcohol in a controlled single pour from the pouring spout; wherein the predetermined volume is selected from the group consisting of one ounce (1 oz.) and one-and-a-half ounces (1.5 oz.); wherein the metered tap is adapted to accurately pour the predetermined volume with substantial precision; wherein the metered tap is selectively movable between a retracted configuration and an extended configuration; wherein, in the retracted configuration, metered tap is adapted to be located within the container; wherein, in the extended configuration, the pouring spout is extended and pulled out relative to the retracted configuration, and adapted for pouring the alcohol; and
a sliding section shaped to define an internal chamber that is sized to contain the predetermined volume with the aforesaid substantial precision; wherein the sliding section has a top portion that is shaped to define one or more fill openings into the internal chamber; wherein, in the retracted configuration, the sliding section is adapted to be located within the container such that the alcohol flows from the internal reservoir into the internal chamber through the fill openings; wherein, in the extended configuration, (i) the sliding section is extended and pulled out relative to the retracted configuration, (ii) the sliding section is adapted to block the aforesaid flow of the alcohol from the internal reservoir through the fill openings, and (iii) when the pouring spout is selectively actuated, the alcohol is dispensed and empties from the internal chamber at least in part by gravity flow; and wherein in the extended configuration, after the internal chamber has emptied, the sliding section is adapted to block further flow of the alcohol from the pouring spout.

8. A metered tap according to claim 7, wherein the sliding section has a bottom portion with a downwards incline, inside the internal chamber, toward the pouring spout; wherein, in the extended configuration when the pouring spout is selectively actuated, the downwards incline inside the internal chamber dispenses the alcohol from the internal chamber at least in part by gravity flow as aforesaid.

9. A metered tap according to claim 7, wherein the pouring spout has a top spout portion and two flanking paddles; and wherein the pouring spout is selectively actuated as aforesaid, to empty the internal chamber, by pulling up on the flanking paddles while holding down top spout portion.

10. A metered tap according to claim 7, wherein the metered tap is adapted to be selectively removable from the container.
